(19) United States
(12) Patent Application Publication
(10) Pub. No.: US 2026/0352552 A1
(43) Pub. Date: Nov. 5, 2026

(54) CREATING AND MANAGING CLOUD INFRASTRUCTURES WITH CONTINUOUS COMPLIANCE

(71) Applicant: ASTRAOPS PRIVATE LIMITED, Pollachi (IN)

(72) Inventor: Gokul NAGASUBRAMANIYAN, Pollachi (IN)

(73) Assignee: ASTRAOPS PRIVATE LIMITED, Pollachi (IN)

(21) Appl. No.: 19/376,516

(22) Filed: Oct. 31, 2025

(30) Foreign Application Priority Data
Apr. 30, 2025 (IN) 202541041975

(51) Int. Cl. H04L 41/0896; H04L 41/0894

(52) U.S. Cl. CPC H04L 41/0896; H04L 41/0894

(57) ABSTRACT

Embodiments herein disclose systems and methods for managing the cloud infrastructure. The method includes configuring at least one compliance policy in the system to define the rules and standards that at least one cloud resources must follow. The method further includes automatically and continuously scanning at least one deployed cloud resource at a regular and predefined time interval to ensure the at least one deployed cloud resource comply with configured at least one compliance policy. The method further includes automatically detecting at least one deviation and at least one violation in real-time from the at least one compliance policy. The method further includes generating at least one of: an alert and a notification to a relevant stakeholder of the system.

### CROSS REFERENCE TO RELATED APPLICATION

This application is based on and derives the benefit of Indian Provisional Application 202541041975, the contents of which are incorporated herein by reference.

### TECHNICAL FIELD

Embodiments disclosed herein relate to creating and managing a cloud infrastructure, and more specifically, systems and methods for creating and managing the cloud infrastructures with continuous compliance.

### BACKGROUND

Currently, a cloud service provider offers a wide range of services that allow a customer to deploy and manage diverse workloads (e.g., virtual machine, container, application or the like). However, the customer often invests significant time and effort in building and maintaining cloud infrastructures across multiple platforms to meet their business requirements. While infrastructure-as-code tools like Terraform® may automate the provisioning and management of resources across different cloud providers, the infrastructure-as-code tools may not be supported by a customer’s primary cloud management platform. Therefore, the cloud management platform integrates a support for tools capable of managing both cloud-based and on-premises infrastructures are highly desirable.

Conventional tools and systems enable a user (or customer) to create an architecture in a normal image format. A code has to be written for each component added in an image as the system doesn't use intelligence techniques. The image created is just a representation of the cloud architecture and then by using a cloud coding tool like terraform or any other coding tool the code is written in a back-end of the architecture. So, the user needs to write code snippets for each and every component drawn in the image in the architecture. The code has to be written for each component and the code may be saved in a library such as GitHub. The code needs to be validated manually, once the code is validated, a continuous integration or a continuous deployment (CI/CD) pipeline is set up that will trigger a job to deploy the code into a cloud. Further, cloud components will be running in the cloud. In an infrastructure as a code platform, the diagram created and the code snippet written always has to be in synchronization. If there is any modification in the code, there has to be modification in the diagram and vice versa. For example, if the user has modified something in the code and not updated in the diagram, so the diagram and the code both are out of synchronization. Also, if the user directly made any changes in the cloud, then also there will be no change between the components, and the code, the components, and the cloud are out of synchronization. All the parts of the images and the code will be out of synchronization and the user may not be aware of the changes as the changes are reflected only on deployment. Further, the user may find it difficult to rollback to an original version of the infrastructure as a code whenever the infrastructure as a code is required.

Also, existing method and system does not ensure that cloud architectures remain compliant with predefined policies by continuously monitoring deployed resources. Consider a financial services company that uses AWS to deploy microservices across multiple accounts and regions. The company is required to comply with strict regulatory policies, such as encryption of all data at rest and specific IAM role restrictions. They use periodic manual audits and some static configuration templates (like AWS CloudFormation or Terraform) to deploy their infrastructure according to these compliance policies. However, once the infrastructure is deployed, there is no automated system in place that continuously monitors changes to the deployed resources in real-time. As a result, if a developer unintentionally modifies an S3 bucket policy to allow public access, or if someone attaches an overly permissive IAM role to an EC2 instance, these changes go undetected until the next audit which could be weeks later. This creates a compliance gap and increases the risk of data breaches and regulatory violations. This example illustrates how existing methods that rely on periodic checks or static enforcement at deployment time do not ensure ongoing compliance. A system that continuously monitors deployed resources and immediately flags or remediates policy violations would be needed to address this gap.

Hence, there is a need in the art for solutions which will overcome the above-mentioned drawback(s), among others.

### SUMMARY

The principal object of embodiments herein is to disclose systems and methods for creating and managing cloud infrastructures using an Infrastructure as a diagram (IAD) while cloud architectures remain compliant with predefined policies by continuously monitoring deployed resources.

Another object of embodiments herein is to receive at least one input as at least one component related to the cloud architecture on a visual interface from a user for creating the Infrastructure as a diagram (IAD) for the cloud architecture.

Another object of embodiments herein is to configure least one compliance policy in the system to define the rules and standards that at least one cloud resources must follow.

Another object of embodiments herein is to automatically and continuously scan at least one deployed cloud resource at a regular and predefined time interval to ensure the at least one deployed cloud resource comply with configured at least one compliance policy.

Another object of embodiments herein is to automatically detect at least one deviation and at least one violation in real-time from the at least one compliance policy associated with the Infrastructure as a diagram (IAD).

Another object of embodiments herein is to generate at least one of: an alert and a notification to a relevant stakeholder of the system on detecting the at least one deviation and the at least one violation in real-time from the at least one compliance policy.

Another object of embodiments herein is to automatically validate, the Infrastructure as a diagram (IAD) by detecting and resolving a layout flaw and a misconfiguration in the Infrastructure as a diagram (IAD).

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustrated drawings. Embodiments herein are illustrated by way of examples in the accompanying drawings, and in which:

FIG. 1 illustrates various hardware elements of a system for creating and managing a cloud infrastructure using an Infrastructure as a diagram (IAD) while cloud architectures remain compliant with predefined policies by continuously monitoring deployed resources, according to embodiments as disclosed herein;

FIG. 2 shows a block diagram illustrating an operation of a user handling engine, according to embodiments as disclosed herein;

FIG. 3 shows an example showing the user handling engine, according to embodiments as disclosed herein;

FIG. 4 shows a block diagram illustrating an operation of an architecture data handling engine, according to embodiments as disclosed herein;

FIG. 5 shows an example screenshot showing the architecture data handling engine, according to embodiments as disclosed herein;

FIG. 6 shows a block diagram illustrating an operation of a template handling engine, according to embodiments as disclosed herein;

FIG. 7 shows an example screenshot showing the template handling engine, according to embodiments as disclosed herein;

FIG. 8 shows a block diagram illustrating an operation of an import data handling engine, according to embodiments as disclosed herein;

FIG. 9 shows an example screenshot showing the import data handling engine, according to embodiments as disclosed herein;

FIG. 10 shows a block diagram illustrating an operation of a price information handling engine, according to embodiments as disclosed herein;

FIG. 11 shows an example screenshot illustrating the price information handling engine, according to embodiments as disclosed herein;

FIG. 12. shows a block diagram illustrating an operation of a validation handling engine, according to embodiments as disclosed herein;

FIG. 13 shows an example screenshot illustrating the validation handling engine, according to embodiments as disclosed herein;

FIG. 14 shows a block diagram illustrating an operation of a version handling engine, according to embodiments as disclosed herein;

FIG. 15 is an example screenshot illustrating the version handling engine, according to embodiments as disclosed herein;

FIG. 16 shows a block diagram illustrating an operation of an approval handling engine, according to embodiments as disclosed herein;

FIG. 17 shows an example screenshot illustrating the approval handling engine, according to embodiments as disclosed herein;

FIG. 18 shows a block diagram illustrating an operation of an operation of a deployment handling engine, according to embodiments as disclosed herein;

FIG. 19 shows an example screenshot illustrating the deployment handling engine, according to embodiments as disclosed herein;

FIG. 20 shows a block diagram illustrating an operation of an AI handling engine, according to embodiments as disclosed herein;

FIG. 21 shows an example screenshot illustrating the AI handling engine, according to embodiments as disclosed herein;

FIG. 22 shows a block diagram for the compliance handling engine 132, according to embodiments as disclosed herein;

FIG. 23 shows a flowchart for a method for creating and managing a cloud infrastructure while cloud architectures remain compliant with predefined policies by continuously monitoring deployed resources, according to embodiments as disclosed herein; and

FIG. 24 shows a flowchart for a method for managing continuous compliance while managing a cloud infrastructure, according to embodiments as disclosed herein

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases "exemplary", “example”, “illustration”, “in an instance”, “and the like”, “and so on”, “etc.”, “etcetera”, “e.g.,” , “i.e.,” are merely used herein to mean "serving as an example, instance, or illustration." Any embodiment or implementation of the present subject matter described herein using the words/phrases "exemplary", “example”, “illustration”, “in an instance”, “and the like”, “and so on”, “etc.”, “etcetera”, “e.g.,” , “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve a cloud infrastructure platform for creating and managing a cloud infrastructure, based on the customer business requirement while cloud architectures remain compliant with predefined policies by continuously monitoring deployed resources. The proposed method and system provides an artificial intelligence (AI) powered multi cloud orchestration system. The proposed method and system simplifies cloud operations by supporting creation of cloud architecture infrastructure as a diagram (IAD). The proposed method and system provides detecting drift in the cloud infrastructure while creating the infrastructure as a diagram (IAD) and providing possible remediation in an effective manner. The proposed method and system supports continuous compliance and security by monitoring the compliance of the infrastructure as a diagram (IAD) with the compliance policies. The proposed method and system offers a ready-to-use package covering multiple core business functions, as business stack as a service (BSaaS). The proposed method and system provides unified monitoring by providing a system to create cloud infrastructure as a diagram, monitor the infrastructure as a diagram (IAD) creation, deploy the infrastructure as a diagram, detect drift in the cloud infrastructure, and also monitor the policy compliance of the created cloud infrastructure. The proposed method and system provides a cost-effective solution by integrating the above-mentioned features into a single system. Embodiments herein provide a system that benefits various stakeholders such as business leaders, IT executives, security and compliance teams, product owners, cloud architects, and DevOps and cloud platform engineers.

Embodiments herein provide cloud design, deployment, management, compliance, and import unified on one platform. The proposed method and system reduce time spent on cloud operations by providing a drag and drop interface for cloud components. The proposed method and system utilize AI powered insights, auto-validation, drift detection and remediation and more. The proposed method and system utilize AI-powered cloud selection and cross-cloud cost optimization. The proposed method and system estimates budgets and manages the budget by allowing the budget within pre-approved limits by providing full visibility into costs as the infrastructure is being created, rather than uncovering the cost later. The proposed method and system simplifies compliance with AI-powered adherence and pre-configured templates. The proposed method and system ensures continuous compliance with AI-powered monitoring and alerts. The proposed method and system protect sensitive data and meet stringent compliance standards like ISO 27001, System and Organization Controls2 (SOC2), Health Insurance Portability and Accountability Act (HIPAA), General Data Protection Regulation (GDPR), and Payment Card Industry Data Security Standard (PCI DSS).

Embodiments herein may abstract away technical complexities of preparing a cloud infrastructure. The proposed method and system may avoid vendor lock-in and expensive costs in hiring and training. Embodiments herein may empower a business team with real-time control using AI-powered approval workflows which help ensure budget adherence, prevent security breaches, and eliminate uncontrolled changes.

Embodiments herein have features such as multiple cloud support, cloud control with multiple projects and one dashboard, AI- powered architecture having auto validation with chatbot, auto-validation, drift detection and remediation and more. The proposed method and system utilizes AI-powered cloud selection and cross-cloud cost optimization. The proposed method and system estimates budgets and manages the budget by allowing the budget within pre-approved limits by providing full visibility into costs as the infrastructure is being created, rather than uncovering the cost later. Embodiments herein simplifies compliance with AI-powered adherence and pre-configured templates.

Embodiments herein provide multi cloud with drag and drop interface. Embodiments herein provide streamlined deployment to AWS, Azure, GCP - speed, reliability, and safety. Embodiments herein provide streamlined configuration with intuitive tools for faster, smarter deployments. Embodiments herein provide streamlined resource categorization with cloud resources categorized into network components, and storage for both AWS and Azure.

Embodiments herein provide one click deployment without the use of continuous integration and continuous deployment (CI/CD) pipelines. Embodiments herein perform deployments without setting up CI/CD pipelines. Embodiments herein provide live activity logs in a console. Embodiments herein may highlight errors instantly on detection, with log highlights. Embodiments herein may be able to perform parallel deployments.

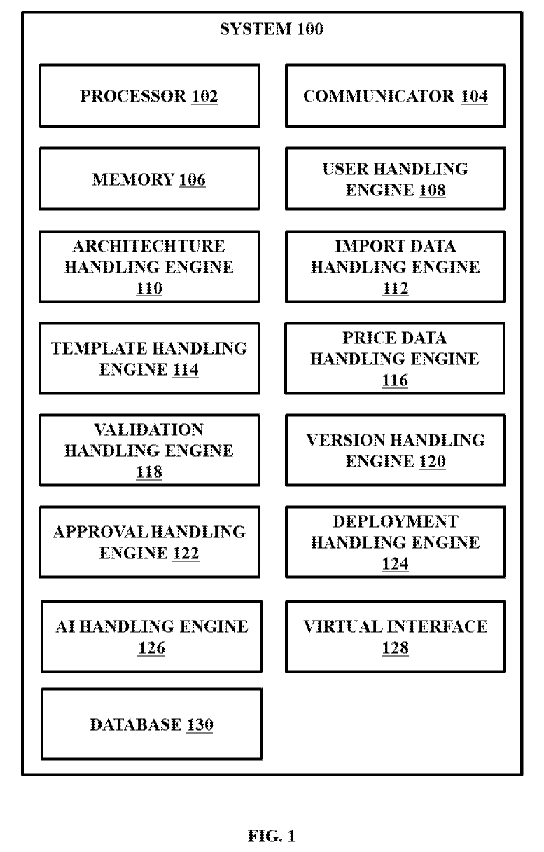

Referring now to the drawings, and more particularly to FIGS. 1 through 24, where similar reference characters denote corresponding features consistently throughout the figures, there are shown at least one embodiment.

FIG. 1 illustrates a block diagram of a system 100 (or cloud infrastructure platform 100) for creating and managing a cloud infrastructure using an Infrastructure as a diagram (IAD) while cloud architectures remain compliant with predefined policies by continuously monitoring deployed resources, according to embodiments as disclosed herein. The system 100 can be an electronic device. The electronic device can also be, for example, but not limited to a laptop, a desktop computer, a notebook, a Device-to-Device (D2D) device, a vehicle to everything (V2X) device, a smartphone, a foldable phone, a smart TV, a tablet, an immersive device, an internet of things (IoT) device, a virtual reality (VR) device, an augmented (AR) device, an Head-Mounted Display (HMD) device or the like.

The system 100 includes a processor 102, a communicator 104, a memory 106, a user handling engine 108, an architecture data handling engine 110, an import handling engine 112, a template handling engine 114, a price information handling engine 116, a validation handling engine 118, a version handling engine 120, an approval handling engine 122, a deployment handling engine 124, an AI handling engine 126, a virtual interface 128, a database 130, and a compliance handling engine 132.

The processor 102, the communicator 104, the memory 106, and the user handling engine 108, the architecture data handling engine 110, the import handling engine 112, the template handling engine 114, the price information handling engine 116, the validation handling engine 118, the version handling engine 120, the approval handling engine 122, the deployment handling engine 124, and the AI handling engine 126, the virtual interface 128, the database 130, and the compliance handling engine 132 communicate with each other.

The processor 102 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 102 may include multiple cores and is configured to execute the instructions stored in the memory 106.

In an embodiment herein, the processor 102 is configured to execute instructions stored in the memory 106 and to perform various processes. The communicator 104 is configured for communicating internally between internal hardware components and with external devices via one or more networks. In an embodiment, the communicator 104 includes an electronic circuit specific to a standard that enables wired or wireless communication. The communicator 104 is configured to communicate internally between internal hardware components of the system 100 and with external devices via one or more networks.

The memory 106 also stores instructions to be executed by the processor 102. The memory 106 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 106 may, in some examples, be considered a non-transitory storage medium. The term “non-transitory” may indicate that the storage medium is not embodied in a carrier wave or a propagated signal. However, the term “non-transitory” should not be interpreted that the memory 106 is non-movable. In certain examples, a non-transitory storage medium may store data that can, over time, change (e.g., in Random Access Memory (RAM) or cache).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

In an embodiment, the user handling engine 108 is responsible for managing individual, business, and admin users, their roles, permissions, and access within the cloud infrastructure platform 100. The user handling engine 108 receives a request through the processor 102 from an administrator user of the system 100 to invite the users. An invitation is sent by the system 100 to the selected users. In an embodiment herein, the request from the administrator user of the system 100 to invite the users is sent through an email or other possible communication mode.

The user handling engine 108 enables the self-management of accounts, and ensures a secure authentication and authorization mechanisms in the system 100. The user may be a registered user. The user handling engine 108 may receive a registration request from the user. The registration request comprises at least one of: registration request details from an individual user and registration request details from a business user.

In an embodiment herein, the registration request from the individual user may be for registering independently to manage cloud environments. The system 100 may enable the registered individual user to create, modify, and deploy the cloud resources on the system 100. The system 100 may enable the registered individual user to manage personal projects and configurations.

In an embodiment herein, the business user represents an organization for managing multiple users. Each of the business user has access to at least one of: a dedicated sub-domain, an isolated tenant database, and a dedicated user pool according to a role and a hierarchy of the each of the business user. The system 100 enables the business user to create teams, assign roles, set permissions, set a budget limit, and make a compliance template. A shared cloud infrastructure, a billing, and a compliance may be managed by the business user of the system 100.

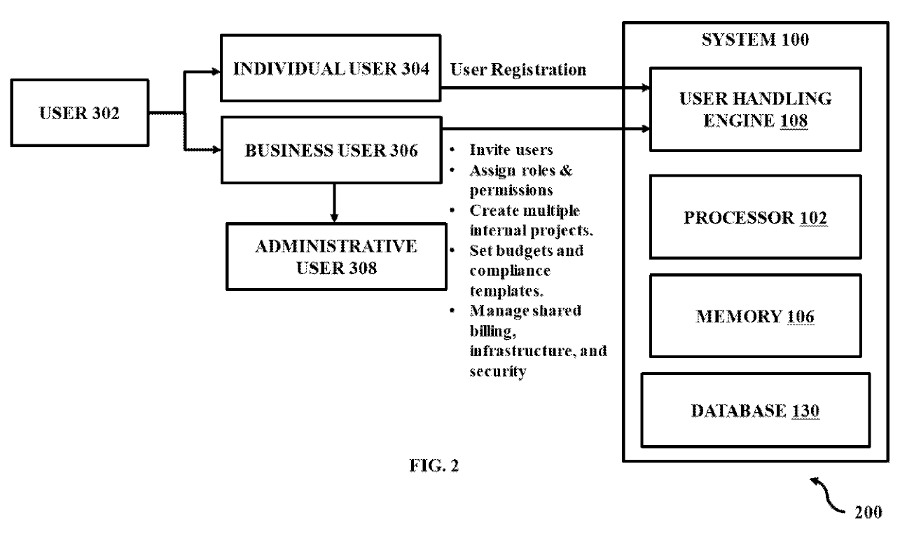

In an embodiment herein, the user handling engine 108 enables the administrative user 308 to self-managed user administration combined with admin-initiated user onboarding and the multi-tiered user architecture with separate workflows for individual and business users is achieved. Further, the operation of the user handling engine 108 is explained in FIG. 2.

In an embodiment herein, the architecture data handling engine 110 enables the users to design high-level cloud architectures (HLD), set the budget limits, and send the cloud architecture and budget plan for approval before deployment. The architecture data handling engine 110 provides a visual drag and-drop interface for selecting cloud components based on the chosen cloud provider.

In an embodiment herein, the system 100 receives at least one selection of the cloud environment from the set of cloud environments to create the infrastructure as a diagram (IAD)of the cloud architecture. Based on the selected cloud environment, at least one component library is dynamically adjusted. An internal data store is maintained for the cloud components against each cloud providers. Based on user selected cloud provider, the system 100 will display the cloud components specific to that Cloud Provider. The user may provide a selection of a cloud provider in the system 100. For example, the cloud provider can be, AWS, Azure, Google Cloud Platform (GCP), etc.. Based on the selection, the architecture data handling engine 110, displays on the virtual interface 128, the relevant cloud components for selection to the user. For example, Elastic Compute Cloud (EC2) for AWS, Compute Engine for GCP, Virtual Machines for Azure.

In an embodiment herein, the system 100 supports a multi-cloud environment. The user is allowed to create the cloud architecture in one of the selected cloud environment from a set of known cloud environments. Each of the cloud environment is integrated within the system 100 with a separate configuration capability, a validation capability, and a budgeting capability.

In an embodiment herein, the system 100 receives at least one input on the visual interface 128 from the user for creating an infrastructure as a diagram (IAD) for the cloud architecture through the architecture data handling engine 110. The at least one input includes at least one component related to the cloud architecture. The at least one component may include a cloud resource. The at least one component includes a computing component, a storage component, a networking component, a monitoring component, and a logging component. A relationship between the at least one component is visually and logically enforced and shown in the system 100. In an embodiment herein, a code for the at least one component added is pre-fetched in a back end from at least one component library in the database 130 when the component is added in the system through the visual interface 128.

In an embodiment herein, the at least one input is received through at least one of: a Canva page, at least one pre-defined system template and a framework, importing from at least one existing cloud resource, artificial intelligence powered query for automatic diagram generation, and dragging and dropping from the visual interface on the Canva page for creating the infrastructure as a diagram (IAD)of the cloud architecture.

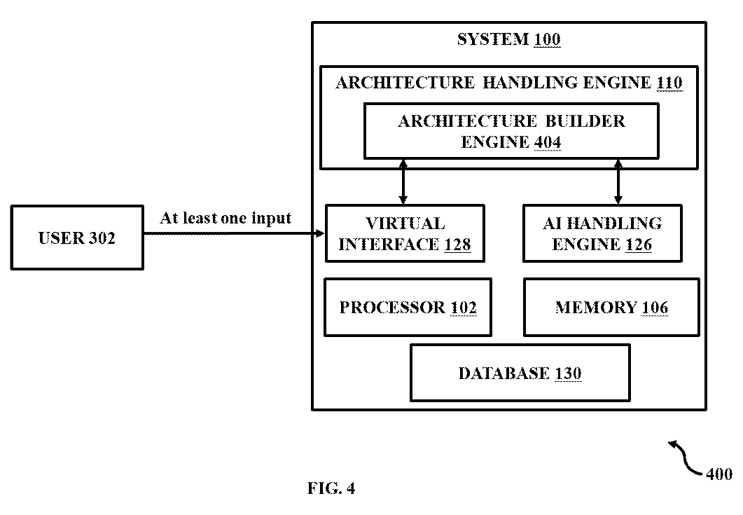

Further, the operation of the architecture data handling engine 126 is explained in FIG. 4.

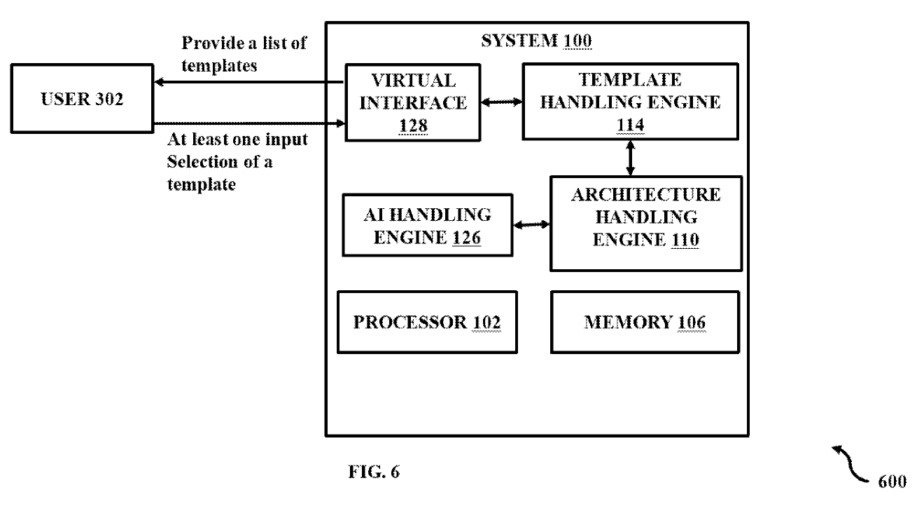

In an embodiment herein, the system 100 manages cloud architecture templates through the template handling engine 114. The template handling engine 114 provides a structured approach to managing the cloud architecture templates, ensuring consistency across the individual user, the businesses, and the organizations. Further, the template handling engine 114 supports a global, an organization-specific, and a user-defined templates, along with features for the template sharing and adding to favorites. Further, the operation of the template handling engine 114 is explained in FIG. 6.

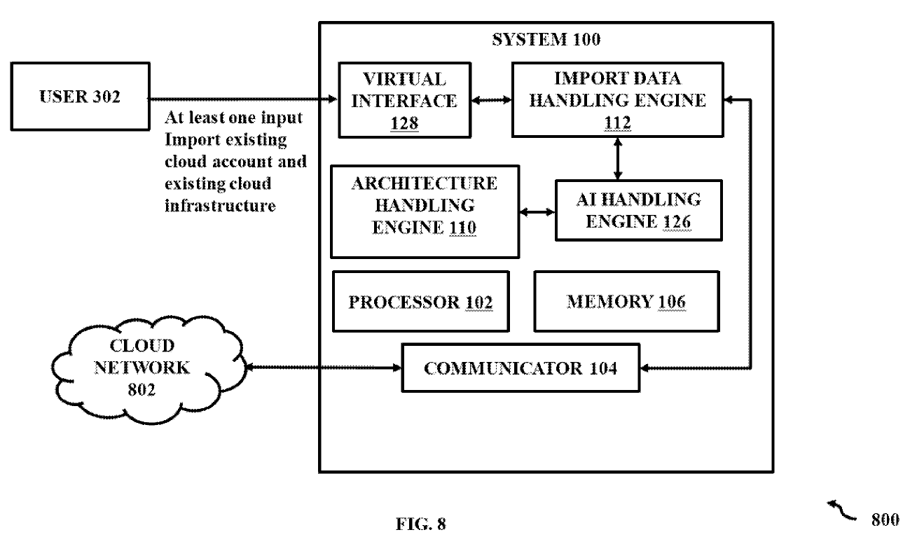

In an embodiment herein, the existing cloud resources are imported through the import handling engine 112. The import handling engine 112 enables the users to retrieve and import existing cloud resources from supported cloud providers. The importing of existing cloud resources allows seamless integration of the existing cloud infrastructure into the system 100 for further architecture design, validation, cost estimation, and deployment. Further, the import handling engine 112 scans and lists all available resources in the selected cloud account. The import handling engine 112 provides an artificial intelligence (AI) assisted mapping. The import handling engine 112 automatically generates the infrastructure as a diagram (IAD)from the imported resources considering the relationships between the cloud resources. Further, the operation of the import handling engine 112 is explained in FIG. 8.

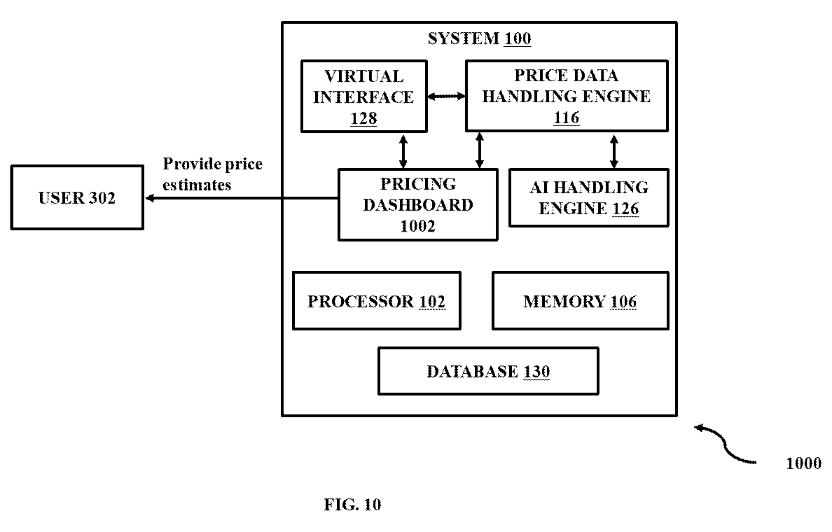

In an embodiment herein, the system 100 may estimate automatically, through the price information handling engine 116, a costing of the generated cloud architecture according to the at least one component added in the infrastructure as a diagram (IAD)for the cloud architecture. The price information handling engine 116 allows the users to estimate, configure, and manage cloud service costs based on the selected architecture components. Further, the price information handling engine 116 provides a budget enforcement, cost forecasting, and approval workflows before deployment. By using the price information handling engine 116, the users can set project-wide budget limits. The system 100 flags selections exceeding budget thresholds. The price information handling engine 116 alerts the users when the estimated costs approach budget limits. Further, the price information handling engine 116 provides a pricing dashboard 1002 with features like real-time cost estimates, displaying total cost by the service and other related details. Further, the price information handling engine 116 provides an export functionality by project, and export costs for a specific project. Further, the price information handling engine 116 supports various formats (e.g., CSV, Excel, PDF or the like). Further, the operation of the price information handling engine 116 is explained in FIG. 10.

In an embodiment herein, the system 100 validates automatically, through the validation handling engine 118, the infrastructure as a diagram (IAD)generated by receiving the at least one input. The validation handling engine 118 ensures the correctness of cloud architecture configurations. Further, the validation handling engine 118 detects and prevents misconfigurations when the cloud components obtained from different providers are incorrectly mixed or when incompatible services are used together. Further, the validation handling engine 118 prevents incorrect mixing of cloud provider services. Further, the validation handling engine 118 blocks missing configurations and notifies users. Further, the validation handling engine 118 provides a service dependency validation. Further, the validation handling engine 118 checks against cloud provider restriction and rate limits. Further, the validation handling engine 118 provides the cost constraint validation, and compares estimated cost with the allocated budget to show the relevant suggestion. Further, the validation handling engine 118 blocks configurations exceeding budget and suggests optimizations.

In an embodiment herein, the validation handling engine 118 prevents misconfigurations and incompatible service selections across multiple cloud providers. The validation handling engine 118 cross checks the dependencies of the components using the artificial intelligence engine 126 to detect missing configurations and service prerequisites of the infrastructure as a diagram (IAD)before deployment.

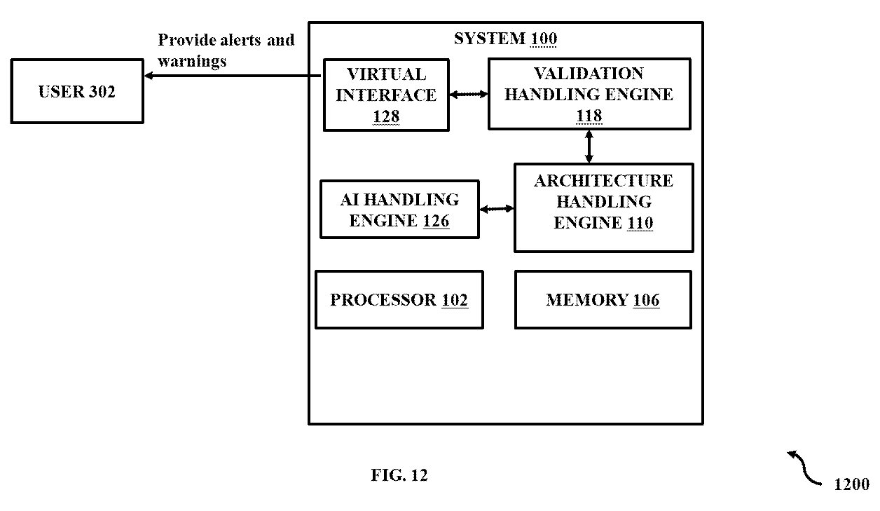

Further, the operation of the validation handling engine 118 is explained in FIG. 12.

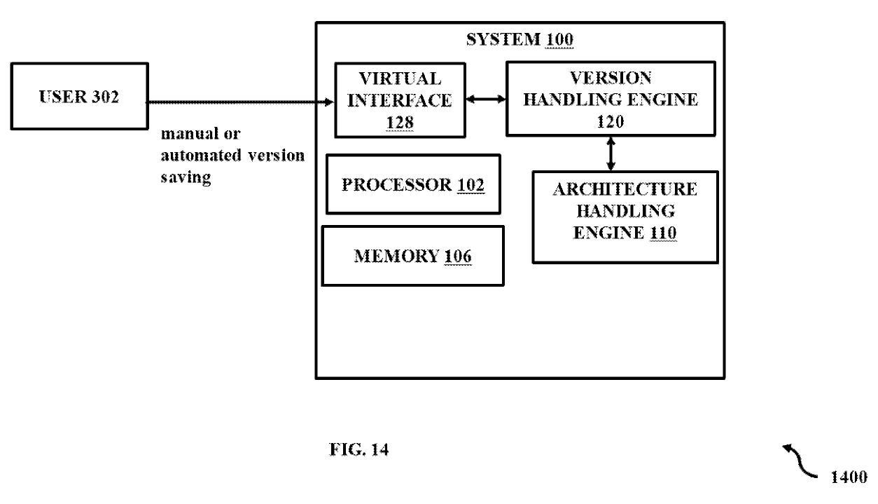

In an embodiment herein, the system 100 maintains a version history having a chronological log of a version of the infrastructure as a diagram (IAD)of the cloud architect. The user may manually save each version of the infrastructure as a diagram (IAD)for a future reference. Each version is saved with a timestamp and a tag with a user identity associated with a creator, a modifier, and an approver. The version handling engine 120 allows the users to track, manage, and restore different versions of the architecture designs (explained in FIG. 14). The version handling engine 120 provides a history of changes, enables comparison between versions, and ensures seamless rollback when necessary.

By using the version handling engine 120, the users can access the full history of versions for each architecture. The users can submit the latest version or the suitable version for the approval. In an embodiment herein, the system 100 automatically creates a new version whenever a user makes changes, submits for approval, updates or deploys the configuration and the changes in the architecture. The users can compare two versions or multiple versions side-by-side to view differences in added components, settings and budget changes in the architecture.

In an embodiment herein, the version handling engine 120 provides an automated versioning system (not shown) that tracks and stores every architecture modification. The version handling engine 110 provides a one-click rollback mechanism with pre-validation checks. The version handling engine 120 provides an approval-driven version management with interactive review features. The version handling engine 110 provides comprehensive audit-trail and compliance tracking for architecture versions. Further, the operation of the version handling engine 110 is explained in FIG. 14.

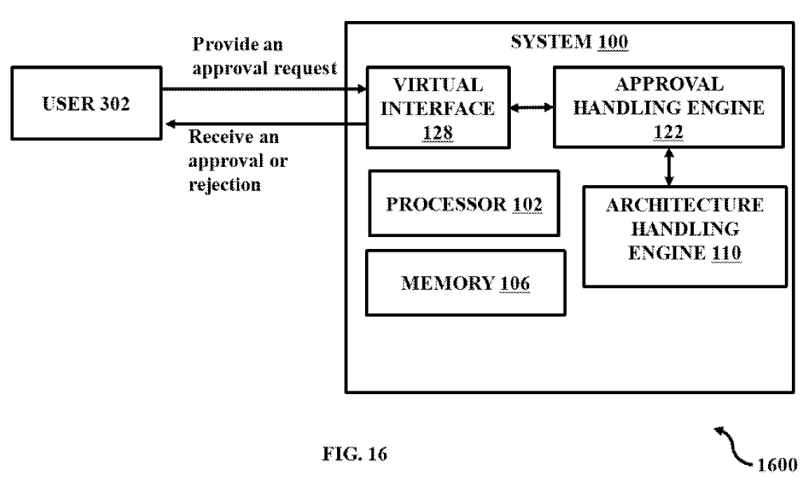

In an embodiment herein, the system 100 approves the at least one of: the infrastructure as a diagram (IAD)for the cloud architecture, the budget plan, and the security configuration through the approval handling engine 122 on receiving at least one approval request from the user. The approval handling engine 122 manages approvals for both finance and architecture workflows. The approval handling engine 122 ensures that budgets, costs, and architectural decisions are reviewed and approved before implementation. The system 100 supports multi-level approvals, automated checks, and role-based access control. The operation of the approval handling engine 122 is explained in FIG. 16.

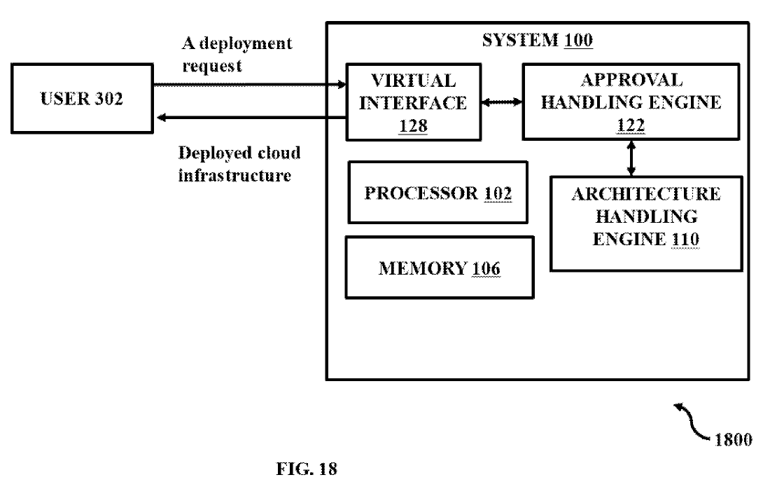

In an embodiment herein, the system 100 may receive a request to deploy a selected cloud architecture diagram from the user from a list of approved cloud architecture. The selected at least one cloud architecture is deployed using an official cloud Software Development Kit (SDK) by directly interacting with a cloud network so as to eliminate use of infrastructure as a code and eliminate the use of a Continuous Integration and Continuous Deployment (CI/CD) pipeline. The operation of the deployment handling engine 124 is further explained in FIG. 18.

The compliance handling engine 132 ensures that cloud architectures remain compliant with predefined policies by continuously monitoring the deployed cloud resources. The compliance handling engine 132 runs compliance checks at regular intervals, detects deviations, and alerts users when a policy violation occurs. The following are the technical advantages of the compliance handling engine 132:

The compliance handling engine 132 enables compliance policy configuration and continuous policy enforcement with real-time notifications. The compliance handling engine generates alerts by performing autonomous scans, detects, and fixes security and policy violations.

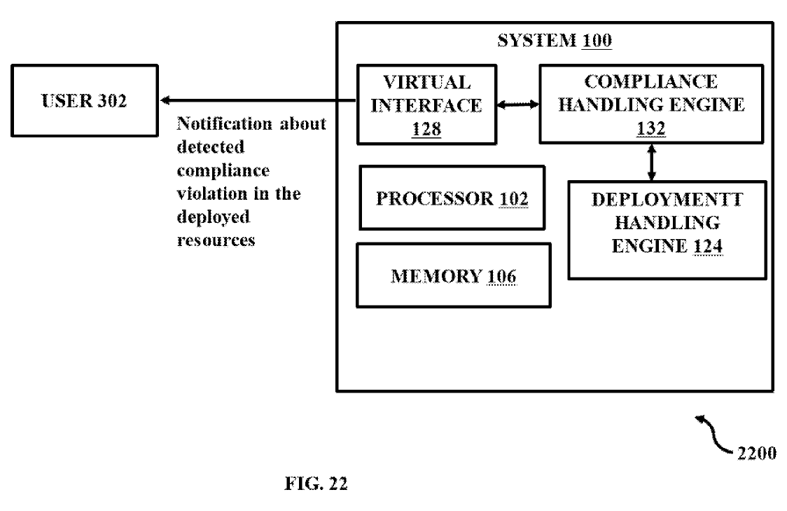

Self-healing cloud compliance system that automatically remediates misconfigurations without manual intervention. Further, the operations of the compliance handling engine 132 is explained in FIG. 22.

The user handling engine 108, the architecture data handling engine 110, the import handling engine 112, the template handling engine 114, the price information handling engine 116, the validation handling engine 118, the version handling engine 120, the approval handling engine 122, the deployment handling engine 124, the AI handling engine 126, and the compliance handling engine 132 are implemented by analog and/or digital circuits such as logic gates, integrated circuits, microprocessors, microcontrollers, memory circuits, passive electronic components, active electronic components, optical components, hardwired circuits and the like, and may optionally be driven by firmware.

FIG. 2 is an example block diagram 200 illustrating an operation of the user handling engine 108, according to embodiments as disclosed herein. The user handling engine 108 receives a registration from the user 302. The user 302 may be at least one of: an individual user 304 interacting with the system 100 or the business user 306 interacting with the system 100.

In an embodiment herein, the individual user 304 may register independently to manage cloud environments. The registration of the individual user 304 may be done through using at least one: existing cloud account using accessing credentials through a Google account, a GitHub account, a Microsoft account or the like. In an embodiment herein, for a new user accessing the system 100 for the first time, the system 100 may ask for a new registration. The user handling engine 108 may receive a registration request from the new individual user 304 through the virtual interface 128. The registration request may include, but is not limited to a name of the new user, a middle name that may be optional, a surname, a username for accessing the system 100, an authentication key, an organization name, a position held, an alternate account id, a phone number, and a purpose for usage (for example). On receiving the registration request, a new personal account of the individual user 304 may be created by the user handling engine 108 using the admin or the authorized person. The authentication key may be a password, a passkey, and a biometric authentication such as a fingerprint, face identity, iris identity, retina identity etc.

In an embodiment herein, upon successful registration and authentication, the individual user 304 may be able to access a personal dashboard on the virtual interface and project management. The individual user 304 may be able to create, modify, deploy and manage cloud infrastructure by instructing the system 100 through the personal dashboard. The individual user 304 may be able to create and save multiple versions of the diagram created, get costing estimates and insights, and get automatic validation of the created diagram in the project management.

In an embodiment herein, the user handling engine 108 may receive the registration request from the business user 306. The business user 306 may represent a part of an organization. The business user 306 may have a position and hierarchy in the organization. Each business user 306 is registered with a verified work email from the organization. Each registration request from the business user 306 may be authorized, authenticated, and approved by an administrative user 308. The administrative user 308 is the user managing the whole system 100 for a certain organization. The administrative user 308 may cross check, compare, and validate credentials provided by the user 302 with pre-fed credentials of employees of the organization in the database 130.

In an embodiment herein, each of the business user 306 may have permission to access a dedicated sub-domain within the system 100. Each of the business user 306 may be provided with a separate and isolated database. The business user 306 having different positions, and different hierarchy level may have varied permissions from each other in the context of access permission of the system 100. For example, a cloud developer may have access only to the personal dashboard to create, modify, deploy, and monitor the personal dashboard. A project manager may have access to multiple project dashboards of multiple users 302. The project manager may have access to approve and reject the created diagrams, and finalize a cloud architecture for deployment.

In an embodiment herein, the user handling engine 108 may receive the registration request from the new business user 306 through the virtual interface 128. On receiving the registration request, a new business account of the organization may be created by the user handling engine 108. The first user of the business account of the system 100 may be a system administrator also referred herein as administrative user 308. The administrative user 308 is capable to invite users 302, assign roles and permissions, create multiple internal projects, set budgets, set compliance templates, manage shared billing, manage cloud infrastructure, and system security.

In an embodiment herein, the administrative user 308 can invite the users 302 to register on the system 100 in several ways, depending on the system’s architecture, available tools, and a desired workflow required according to the type of user 302.

In an embodiment herein, the administrative user 308 may send an email invitation with a registration link of the system 100 to the employees of the organization. The user handling engine 108 may receive the registration of the user 302 through the registration link. The user handling engine 108 may receive the name of the new user, the middle name that may be optional, the surname, the username for accessing the system 100, the authentication key, the organization name, the position held, the alternate account ID, the phone number, and the purpose for usage through the registration link to register the user 302.

In an embodiment herein, the user handling engine 108 may auto generate the email with a unique registration or invitation link, on receiving an instruction from the administrative user 308 to create an automated email with the registration link. The system may receive a set of email ids of the users 302 to whom the registration link is to be shared. The registration link may include a token that expires after a certain time. The token may be tied to a specific email address. The user handling engine 108 may receive the registration of the user 302 as a filled-out registration form and a password entered by the user 302.

In an embodiment herein, the user handling engine 108 may receive pre-registered users 302 from the administrative user 308. The user handling engine 108 creates user accounts with temporary passwords, by receiving the credentials of the user accounts entered manually by the administrative user 308. The user handling engine 108 sends the user credentials through a secure method including, but is not limited to an email, and a messaging system, etc. The user handling engine 108 may prompt the users 302 to change password on accessing the system 100 for a first time.

In an embodiment herein, the user handling engine 108 may receive a self-registration request from the user 302 of the organization. The user handling engine 108 may send a notification to the administrative user 308 of the registration request, where the user handling engine 108 gets an approval to activate the user account from the administrative user 308.

In an embodiment herein, the user handling engine 108 may import existing user credentials from the database 130. The user credentials may be stored as a CSV file or the administrative user 308 uses an application programming interface (API) to add the users 302. The user handling engine 108 sends automatic invitations or credentials to each user 302. The CSV file might include, but is not limited to: a name of the new user, the middle name that may be optional, the surname, the username for accessing the system 100, the authentication key, the organization name, a position held, an alternate account id, a phone number, and a purpose for usage.

In an embodiment herein, the user 302 registered with the system 100 is authenticated by the user handling engine 108 by using username and password, single sign-on (SSO), multi-factor authentication (MFA), and biometric or certificate-based authentication. The password method requires secure password policies for e.g., password complexity, expiry, and reuse limits are enforced by the user handling engine 108. The SSO integrates with platforms like Google, Microsoft, or enterprise identity providers to sign-in through existing accounts on these platforms. The multi-factor authentication (MFA) may have dual authentication or two step authentication that adds an extra layer of security, for example, one- time passwords on message apps and authenticator apps and use of biometrics such as a biometric authentication such a fingerprint, face identity, iris identity, retina identity etc.

In an embodiment herein, the user handling engine 108 may receive a request to generate user roles and access control for each user 302. The user handling engine 108 enables the administrative user 308 to restrict the level of access for each user 302. The administrative user 308 may assign a definite role to the user while inviting the user. For example, the administrative user 308 may define whether the user is an "Admin", "Editor", "Viewer", “Approver” etc., (for example). The administrative user 308 may map the user roles according to the department, or assign a new user to a particular department. Every user may have a minimal necessary permission to access the system 100.

In an embodiment herein, the system 100 enables the administrative user 308 to onboard existing cloud accounts from any supported cloud provider or cloud environments. The existing cloud environment may include, but is not limited to Amazon Web Services (AWS), Microsoft Azure, Google Cloud Platform (GCP), IBM Cloud, Oracle Cloud Infrastructure (OCI), Alibaba Cloud and alike. Connecting the system 100 to the existing cloud account, the accounts become manageable within the system 100.

In an embodiment herein, the system 100 may receive an identity and access management (IAM) credentials. The IAM credentials include an access key identity (ID) and a secret access key. The IAM credentials may include IAM roles and permissions. The IAM Roles and Permissions are part of Identity and Access Management (IAM) that controls who can access into a cloud or IT environment. The IAM roles and permissions are used to grant, restrict, or delegate access to cloud resources in a secure and controlled way. The system 100 receives a cloud account to be added with a cloud environment name, account identity, project identity, subscription identity and region or source scope. The system 100 receives required permissions for secured and limited access. For example, for AWS cloud account, the IAM role is created to build a trust relationship. A policy is received with least-privilege access (e.g., read-only to specific services) with the IAM role. A role Amazon Resource Name (ARN) and an external identity to avoid privilege escalation is received to set up cross account access. For example, for a GCP cloud account, a request to create a service account is received with necessary IAM roles. The system 100 generates a JSON key file and enables required APIs such as Compute Engine API, Cloud Asset API for cloud account access and management. The system 100 may test the connection to ensure credentials and permissions work. The system 100 may verify by listing cloud resources or reading metadata. The system 100 may enable desired modules of the cloud account depending on the system’s 100 requirement. For example, the system 100 enables cloud infrastructure creation and management. The system 100 provides access to the administrative user 308 to view, update, and delete onboarded cloud accounts as needed, ensuring complete lifecycle control of the system 100. The system 100 may activate cloud change management, allowing the administrative user 308 to track, audit, and govern all infrastructure modifications manually or automatically. The creation, validation, approval and deployment of the cloud infrastructure is explained in the description as given below.

In an embodiment herein, upon onboarding of the existing cloud account, the system 100 may receive a request from the user 302 to import existing cloud resources. Upon onboarding of all the existing resources across the cloud account can be discovered and may be imported into the system 100. The cloud resources include for example compute, storage, networking, and security components. The imported cloud resources may be automatically converted into a high-level design (HLD) diagram representation of the cloud infrastructure. Cloud resource importing and creating HLD diagram are explained in the description of import handling engine 114 in FIG. 8. The importing of the existing cloud resources provides a standardized, visual, and editable blueprint of the cloud infrastructure.

In an embodiment herein, the user handling engine 108 may maintain audit trails and activity logs for the invitations sent to the users 302. A track of: a number of the users invited, a number of invited users that registered on the system 100, and the activity log of the user is maintained. An invitation log is maintained to keep a track of a time when the user was invited, a name of an invitee who initiated the invitation, and a name of the invited person. A history of access to the system 100 is maintained with a track of successful and failed attempts.

In an embodiment herein the system 100 receives a request to generate a new project from the administrative user 308. The system 100 may create multiple internal projects by receiving an input from the administrative user 308. The system 100 may receive a name of a project, a number of users assigned to the project, designation and role of each user in the project and duration of the project. For example, the system 100 receives a project name XYZ, ten resources or users are assigned the project, five users are developers, two users are testers, two users are for compliance tracking, and one user for security. The system 100 enables display of each project with the users assigned on selecting to view the project on the virtual interface 128. The display may have a project name, a list of users assigned with the name, email id, designation, time they accessed the system, and the changes done by the user.

In an embodiment herein, the system 100 may receive a request to set the budget of the project created from the administrative user 308 performs at least one of the actions: set the budget, set the compliance templates, manage shared billing, manage cloud infrastructure, and system security. The budget is assigned to prevent cost overruns and track spending on a particular project. The system 100 may receive a threshold limit to be set for the budget for the project. The budget is set according to the components used in the project. For example, the project requires 10 cloud components, each component cost is calculated and total cost is generated based on the cost of each component.

In an embodiment herein, the system 100 may create a budget account for the project created to manage the budget for a particular project.

In an embodiment herein, the system 100 enables the administrative user 308 to set the compliance template. Setting the compliance template for the system 100 involves creating a standardized set of controls, rules, and checks that ensure the system adheres to relevant laws, regulations, industry standards, or internal policies. The template acts as a baseline for auditing, monitoring, and maintaining compliance. The system 100 may identify the compliance requirements according to a regulatory board jurisdiction, an industry standard, and a company-specific security or data handling rules. A scope of the system 100 needs to be defined to understand the environments that need compliance and then define the compliance structure for the system 100.

In an embodiment herein, the system 100 enables the administrative user 308 to manage the cloud infrastructure. The administrative user 308 may set up and configure the cloud resources using the existing cloud accounts and the infrastructure as a diagram. The administrative user 308 may manage the identity of the user, the access of the user, and cloud native security policies. The loud-native security policies are rules and configurations that leverage the built-in security features of the system 100(to protect cloud resources, data, and identities. The security policies are tightly integrated into the system 100, enabling automation, scalability, and continuous enforcement. The administrative user 308 may ensure visibility into system performance and security using cloud native monitoring tools or third-party monitoring tools, and monitoring centralized logs of the system 100. The system 100 may receive threshold values to check anomalies in the logs. The system 100 may generate an alert based on thresholds or anomalies. In an embodiment herein, the administrative user 308 may schedule tasks and cron jobs for timely maintenance, backup of data of the system 100, automated reports, script execution, and other repetitive tasks. The system 100 enables the administrative user 308 to monitor the cloud resources usage and the billing for the cost management. The system 100 enables the administrative user 308 to monitor for OS patching and package updates. The system 100 enables the administrative user 308 to apply and monitor compliance policies, conduct regular audits and generate reports. The system 100 enables the administrative user 308 to maintain documentation of infrastructure setup, change management processes, and recovery procedures.

In an embodiment herein, the system 100 may apply firewall and network security, antivirus and malware protection, file and data security, backups and recovery for security compliance.

In an embodiment herein, the system 100 enables the administrative user 308 to have full control over the cloud management lifecycle within the system 100. The responsibilities and the capabilities include: onboarding at least one cloud account, managing the onboarded cloud account, importing existing cloud resources, converting the imported cloud resources as a higher-level design, and monitoring and managing of the imported resources.

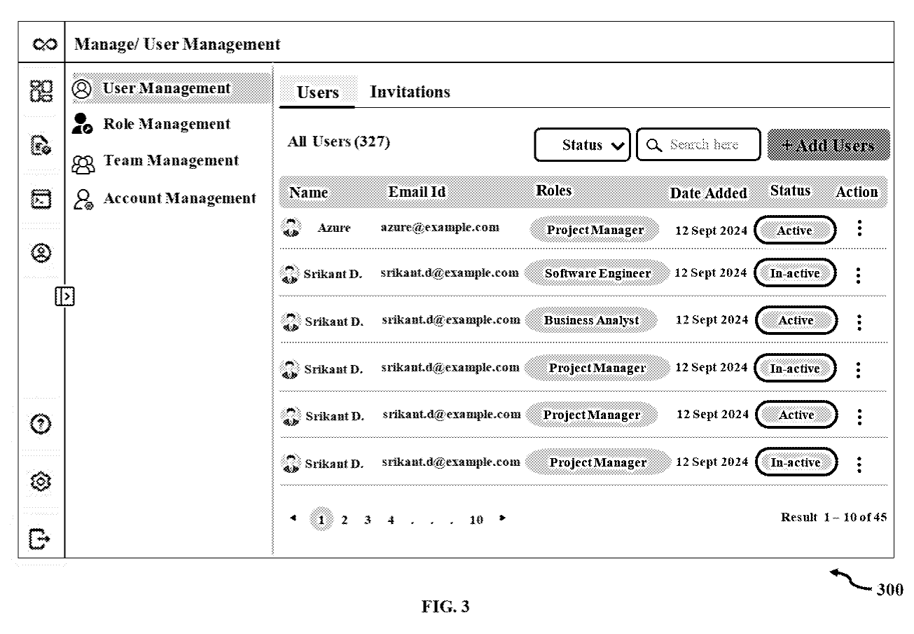

FIG. 3 shows an example screenshot 300 of the user handling engine 108, according to embodiments as disclosed herein. The user handling engine 108 may display on the visual interface 128, a detail about the user management. The user management includes a list of registered or onboarded user accounts. The list also includes the email ids, the position of the user, the date of registration, an activity status, and the activity performed information.

FIG. 4 shows a block diagram 400 illustrating an operation of the architecture data handling engine 110, according to embodiments as disclosed herein. The architecture data handling engine 110 receives at least one input on the visual interface 128 from the user 302 for creating the diagram for the cloud architecture as an infrastructure as the diagram. The at least one input comprises at least one component or the cloud resource related to the cloud architecture. When a user drags and drops a component, a detail and a property of the component is fetched from the front end and sent to the backend for storage in the database. If the user updates the component’s configuration, the change in the component’s configuration is also saved in the backend database. During deployment, the stored data is used to interact with the cloud provider's software development kit (SDK) to provision the appropriate cloud resources. A code for the at least one component added to run as a cloud service is pre-fetched in a back end from at least one component library in the database 130. The code for each of the cloud resource and cloud architecture is pre-fed in the database 130 of the system 100.

In an embodiment herein, the architecture data handling engine 110 receives at least one selection of the cloud environment from the set of cloud environments to create the infrastructure as a diagram (IAD)of the cloud architecture. The set of cloud environments may include, but is not limited to Amazon Web Services (AWS), Microsoft Azure, Google Cloud Platform (GCP), IBM Cloud, Oracle Cloud Infrastructure (OCI), Alibaba Cloud and alike. The system 100 dynamically selects and adjusts the at least one component library based on the selected cloud environment. The internal data store is maintained for the cloud components against each cloud providers. Based on user selected cloud provider, the system 100 will display the cloud components specific to that Cloud Provider.The at least one component may include, but is not limited to at least one of: the computing component, the storage component, the networking component, the monitoring component, and the logging component. Examples of cloud-specific components or cloud resources are: i) for AWS: EC2, Simple Storage Service (S3), Relational Database Service (RDS), Virtual Private Cloud (VPC), Identity and Access Management (IAM), Lambda etc, ii) for Azure: Virtual Machines, Blob Storage, Cosmos DB, Virtual Networks, Azure Functions, iii) for GCP: Compute Engine, Cloud Storage, BigQuery, Cloud Functions.

In an embodiment herein, relationship between the at least one component is visually and logically enforced in the created diagram. The relationship between any two components is stored in the database 130. The infrastructure as a diagram (IAD)clearly shows a connection or dependency between the cloud components using arrows, lines, or groupings that represent how resources or services are connected in the cloud infrastructure. For example, a web server (e.g., EC2 instance) is shown connecting to a database (e.g., RDS or the like) via an arrow labelled “DB connection”. An auto scaling group is visually contained within a VPC subnet, showing deployment context. The infrastructure as a diagram (IAD)reflects actual dependencies or configurations that would be needed to deploy the cloud infrastructure. The relationships are not just visual, the relationship represent real relationships, for example, a load balancer that distributes traffic to EC2 instances, an IAM role assigned to a Lambda function, a security group that allows traffic between specific resources. In an example herein in AWS Cloud Infrastructure Diagram, components listed below are received by the architecture data handling engine 110:
VPC;
Contains subnets;
Subnets host EC2 instances;
EC2 connected to RDS database;
An Internet Gateway connects the public subnet to the internet; and
A Security Group is applied to control access between EC2 and RDS.

Here, the relationships between the components received is enforced as:
VPC → Subnet → EC2;
EC2 ↔ RDS (via SG or direct connection); and
Subnet ↔ Internet Gateway.

The components shown in the example are both visually shown and logically accurate for how the cloud infrastructure must function.

In an embodiment herein, the architecture data handling engine 110 may create a visual high-level design (HLD) of the diagram of the cloud architecture before deployment based on the received at least one input. The system 100 may prompt the user 302 to select one cloud environment at a time, when the cross cloud environment diagrams are not supported. Each of the cloud environment is integrated within the system 100 with the configuration capability, the validation capability, and the budgeting capability.

In an embodiment herein, the at least one input is received through at least one of: a canvas page, at least one pre-defined system template and a framework, importing at least one existing cloud resource, an artificial intelligence powered query for automatic diagram generation, and dragging and dropping from the visual interface on the canvas page for creating the infrastructure as a diagram (IAD)of the cloud architecture. The architecture data handling engine 110 may ensure infrastructure compliance, optimize configurations, and control costs in multi-cloud environments.

As shown in FIG. 4, the system 100 provides an interactive visual display to receive the input by the drag-and-drop builder with smart snapping and connector lines on the visual interface for creating the infrastructure as a diagram (IAD)of the cloud architecture. The system 100 offers an advanced interactive visual display that empowers users 302 to design cloud infrastructure as a diagram through an intuitive drag-and-drop builder. The virtual interface 128 allows users to select the cloud components, for example, the virtual machines, the storage buckets, the databases, and the networking elements from a predefined palette displayed on the virtual interface 128 and place the selected components onto a visual canvas. The drag-and-drop functionality is enhanced by smart snapping, which automatically aligns components to a grid or to one another, maintaining a clean and organized layout. The user 302 may easily draw connector lines between components to represent communication paths, data flows, or service relationships. The connectors are intelligent, snapping to logical connection points and often labelled for clarity (e.g., API call, HTTPS, SSH). The system 100 supports a real-time interaction, allowing the user 302 to adjust, reposition, or delete components seamlessly. The drag and drop interface significantly simplifies the complexity of cloud architecture design, making the system 100 accessible to both technical and non-technical users. Additionally, the drag and drop interface helps prevent design errors by visually validating connections and dependencies between cloud services. By enabling users to build, visualize, and iterate on cloud designs interactively, the system 100 serves as a powerful tool for planning, collaboration, and documentation of infrastructure. The system 100 may also integrate with backend systems to generate deployable configurations or architecture diagrams automatically.

The architecture data handling engine 110 may receive a request to create a new project through the virtual interface 128. The architecture data handling engine 110 may display the canvas page on the virtual interface 128. The canvas page may display prompts to select the cloud environment. Based on the selection of the cloud environment, the architecture data handling engine 110 may display prompts of the cloud resources specific to the cloud environment selected. The architecture data handling engine 110 receives the at least one component or the cloud resource related to the cloud architecture. A code for the at least one component added to run as a cloud service is pre-fetched in the back end from at least one component library in the database 130. The architecture data handling engine 110 may create the visual HLD of the diagram of the cloud architecture before deployment based on the received at least one cloud component, where the relationship between each cloud component is logically and visually enforced.

The architecture builder engine 404 receives the at least one input or a query in a natural language from a chatbot on the virtual interface 128. For example, Build a 3-tier web application on AWS with auto-scaling and a managed database. The architecture builder engine 404 analyses the at least one input by using at the least one AI handling 126. The architecture builder engine 404 preprocesses, tokenizes, and vectorizes each word to pick up the cloud environment and the cloud components required for the HLD diagram. The architecture builder engine 404 identifies the relationships logically between each cloud component identified using the AI handling engine 126. The AI handling engine 126 is pre-trained with logical and visual relationship between each cloud component in each and every cloud environment. After identifying and establishing the logical relationships between the cloud components, the architecture builder engine 404 automatically generates the infrastructure as a diagram for the cloud architecture based on the analysed at least one input. The architecture builder engine 404 validates the infrastructure as a diagram (IAD)by structuring the diagram logically and determining whether at least one layer of the infrastructure as a diagram (IAD)is in place.

The architecture builder engine 404 provides an intelligent cloud assistant helping to design, validate, and optimize the cloud infrastructure using natural language processing and automation. The architecture builder engine 404 accelerates cloud planning with minimal manual effort.

In an embodiment herein, the architecture data handling engine 110 may detect the misalignment and the misconfiguration of the at least one component in the infrastructure as a diagram (IAD)using the AI handling engine 126. The architecture data handling engine 110 utilizes the pre-trained AI handling engine 126 with the logical and the visual relationship between each cloud components in each and every cloud environment to detect the misalignment and the misconfiguration of the at least one component in the infrastructure as a diagram (IAD). The architecture data handling engine 110 automatically resolves the misalignment and misconfiguration of the component in the infrastructure as a diagram (IAD)using the AI handling engine 126. The architecture data handling engine 110 automatically adjusts and aligns a layout of the infrastructure as a diagram (IAD)in a frame of the visual interface 128. The architecture data handling engine 110 automatically analyses the cloud component and the cloud configuration in the cloud architecture diagram with the pre-trained AI handling engine 126 with the logical and the visual relationship between each cloud components. The architecture data handling engine 110 detects visually whether the cloud component are properly nested or connected or not in the diagram, for example an EC2 instance shown outside a subnet. The architecture data handling engine 110 checks whether an invalid or incomplete logical configurations are there in the diagram in comparison to the pre-trained AI handling engine 126 with the logical and the visual relationship between each cloud components. For example, EC2 instance without a security group or missing IAM roles. The architecture data handling engine 110 automatically resolves the issues by repositioning the components visually to match the correct cloud design standards and correcting the configurations to align with the best practices or required infrastructure dependencies.

In an embodiment herein, the architecture data handling engine 110 may receive the input in the form of a pre-built templates aligned with compliance and industry best practices that are ideal for rapid prototyping and standardized deployment patterns. Creating infrastructure as a diagram (IAD)using the template handling engine 114 is explained in FIG. 6.

In an embodiment herein, the architecture data handling engine 110 may import the existing cloud resources from the imported cloud account. The architecture data handling engine 110 may generate the HLD diagram by mapping the imported existing cloud resources in the cloud account. Creating the infrastructure as a diagram (IAD) using the import handling engine 112 is explained in FIG. 8.

In an embodiment herein, the system 100 estimates automatically the costing of the generated cloud architecture. The system 100 generates monthly costs according to a cost of the at least one component added in the infrastructure as a diagram (IAD). The system provides and displays a per service cost breakdown according to the at least one component added in the infrastructure as a diagram (IAD)on the virtual interface 128. Estimation of the costing helps in identifying cost-heavy components at an early stage of creating the cloud architecture. While designing the architecture, the user can view real-time cost estimates for the cloud components being used. The real-time cost estimate aids to identify high-cost components before deployment. The pricing information of the at least one cloud component is fetched directly from the respective cloud providers.

In an embodiment herein, the budget limits are enforced by setting at least one soft budget cap and at least one hard budget cap per cloud architecture. The system 100 monitors the at least one soft budget cap and the at least one hard budget cap while creating the HLD infrastructure as a diagram (IAD)of the cloud architecture. The system 100 generates at least one of: a visual warning and at least one alert on a threshold breach on the at least one soft budget cap and the at least one hard budget cap.

In an embodiment herein, the architecture data handling engine 110 may prompt the user 302 to submit the created infrastructure as a diagram (IAD)for the cloud architecture, the budget plan, and the security configuration for the approval. The system 100 receives the at least one approval request from the user 302. The at least one approval request may include, but is not limited to, at least one shareable diagram file in at least one file format. The file format may include, but is not limited to, an editable hyperlink having a path for the diagram file, an image, and a document. The document may be a PDF document or an XML document. The at least one approval request is routed through a defined approver channel according to a configured role and hierarchy. The configured role may be an assigned approver to approve the approval request after performing a series of checks for validity of the diagram, the budget, and the policy compliance. The system 100 may receive a real-time comment and a feedback on the diagram from the defined approver. The system 100 tracks automatically for at least one infrastructure as a diagram (IAD) change and the at least one version change in the infrastructure as a diagram (IAD). The system 100 may export a compliance report with at least one approval or at least one rejection to the user 302 or a stakeholder.

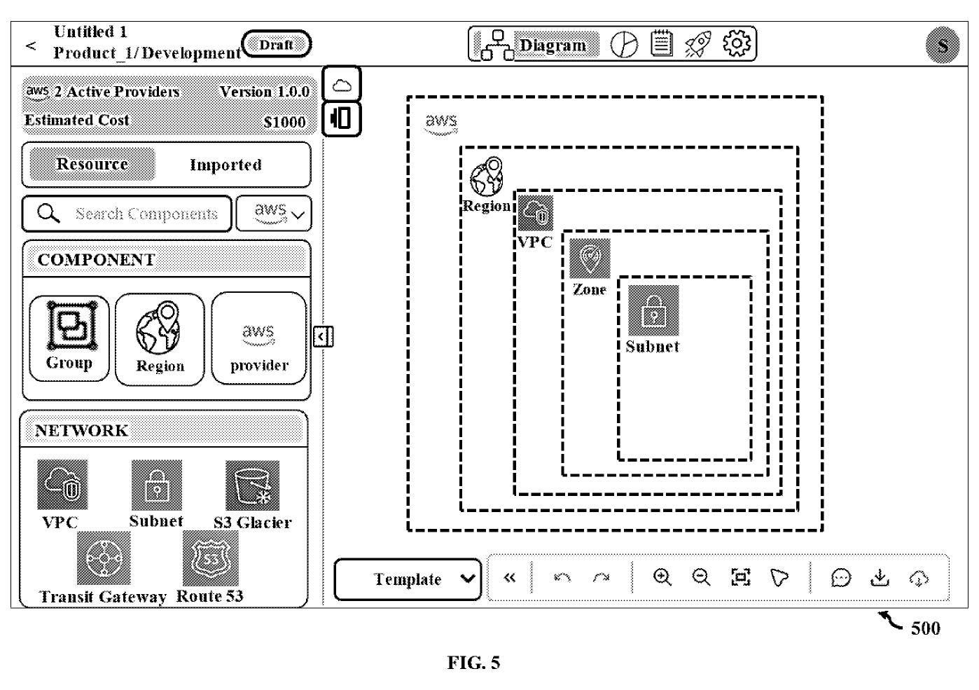

FIG. 5 shows an example screenshot 500 showing the architecture data handling engine 110, according to embodiments as disclosed herein. The architecture data handling engine 110 may display canvas page on the visual interface 128 as shown in FIG. 5. The Canva page may include a side bar for cloud environment, region, and the cloud component selection, and an area to create the HLD diagram.

FIG. 6 shows a block diagram 600 illustrating an operation of the template handling engine 114, according to embodiments as disclosed herein. The architecture data handling engine 110 may receive input in the form of a pre-built templates for cloud architecture diagrams aligned with the compliance and the industry best practices that are ideal for rapid prototyping and standardized deployment patterns. The template handling engine 114 manages multiple cloud architecture templates. The cloud architecture templates are pre-designed blueprints that define how various cloud resources should be structured, configured, and connected both visually (in diagrams) and logically (as-Code). The cloud architecture templates support quickly build, standardize, and deploy reliable, secure, and scalable cloud environments. The template handling engine 114 streamlines cloud architecture by providing reusable blueprints that ensure consistency, compliance, and speed across individuals and organizations. Pre-defined structure includes: a network setup, the compute resources, the databases, the storage, the security, and the monitoring components. The cloud architecture templates are reusable and modular that can be reused across projects, environments, and teams. The cloud architecture templates are secure and compliant to industry standards, often designed to follow best practices and frameworks like CIS Benchmarks, NIST, or ISO 27001. The cloud architecture templates are compatible across cloud architecture environments. The cloud architecture templates are usually accompanied by architecture diagrams showing the logical relationships between components.

In an embodiment herein, the template handling engine 114 has pre-stored readymade templates generated based on industry standards by the system 100. Additionally, the user may create customized high-level designs (HLDs) as templates and reuse the design as templates for future projects.

In an embodiment herein, the type of templates available in the template handling engine 114 may include, but is not limited to, global templates, organization templates, and user templates. The global templates are reusable, standardized infrastructure blueprints designed to be deployed across multiple environments, regions, or accounts often used in enterprise-scale cloud environments to enforce governance, compliance, and architectural consistency globally. The global templates sum up to the best practices for the security, the networking, the identity management, the logging, and the resource provisioning and are designed to work regardless of the region or the team. The global templates are managed and updated on regular time intervals by the template handling engine 114. The organization templates are controlled by organization administrative user 308 who can manage and approve the templates to align with company-specific policies and architecture standards. The administrative user 308 oversees the updates and ensures templates reflect current organizational requirements. The user templates are created and managed by individual user 304 for their personal or business use. The user templates are private and cannot be shared outside the user’s account or organization. When saved, only basic template data is retained—detailed configurations are not saved to maintain security. The user 302 can mark frequently used templates as favorites for quick access during their sessions. The business users 306 can share organization templates across teams in the organization to standardize deployments and promote the best practices.

In an embodiment herein, the template handling engine 114 may display a prompt on the canvas page of the virtual interface 128, for the user 302 to select the template from a list of saved templates. The architecture data handling engine 110 may receive the at least one input as the pre-defined template selected by the user 302 from the template handling engine 114. The architecture data handling engine 110 may create the infrastructure as a diagram (IAD)by using the selected pre-defined templates. The system 100 may receive the request to deploy the infrastructure as a diagram (IAD)of the cloud architecture created by using templates as it is pre-validated and compliant to global policies.

For example, the system 100 provides a pre-built 3-tier architecture template. The user 302 may customize the component configurations within the template and deploy the template directly if the template aligns with the high-level design (HLD) the user 302 intends to create.

In an embodiment herein, the template handling engine 114 enables the users 302 and organizations to work more efficiently by leveraging well-maintained, reusable architecture blueprints. The regular updates and clear ownership help maintain quality and compliance, while privacy controls keep user templates secure.

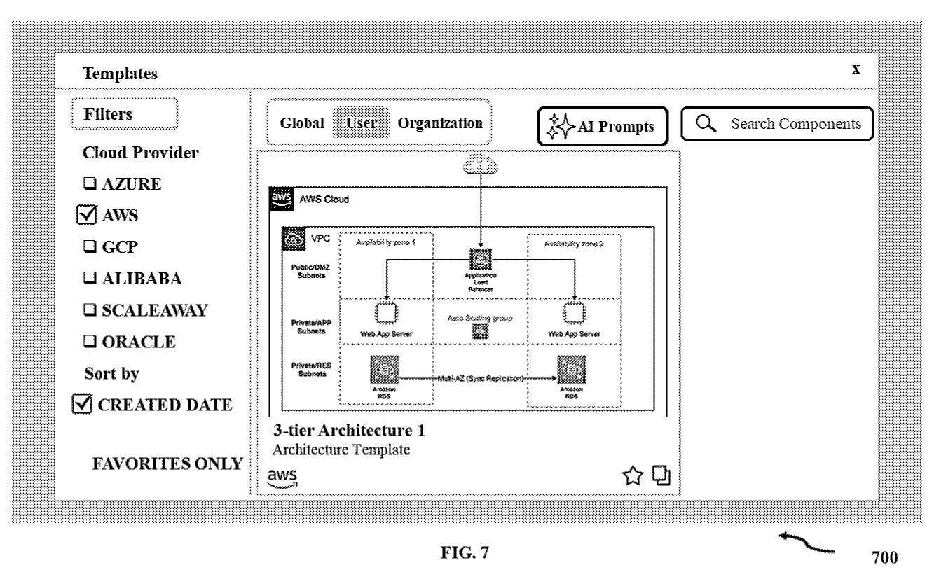

FIG. 7 shows an example screenshot 700 showing the template handling engine 114, according to embodiments as disclosed herein. The template handling engine 114 may display on the visual interface 128, a template page as shown in FIG. 7. The template page may include pre-defined templates, or an imported template to create the HLD diagram.

FIG. 8 shows a block diagram 800 illustrating an operation of the import handling engine 112, according to embodiments as disclosed herein. The system 100 may import the cloud resources from the existing cloud account. The administrative user 308 or the individual user 304 may have onboarded existing cloud account on the system 100 as described in FIG. 2. The system 100 receives a connection request from the user 302 to connect to the existing cloud account through the system 100. The system 100 sends secure access credentials like API keys or roles for authorization and authentication to a cloud network 802 through the communicator 104. AWS receives the IAM role with trust policy for the platform. Azure receives a service principal for app registration. GCP receive account key or work load identity. In an embodiment herein, the system 100 receives the security credentials directly. The system 100 follows an automated workflow e.g., the IAM Role creation through the system 100 for sharing security credentials. The system 100 may use delegated authorization (e.g., OAuth flow for GCP). The system 100 verifies whether the credentials are correct, and checks whether the required permission (e.g., ec2:Describe*, s3:*) are present.

On successful verification, the system 100 validates connection. Once the connection is verified, the system 100 fetches metadata by checking the cloud regions available, existing resources for importing, and cost centres or resource tags. On establishing the secure connection, the credentials or access tokens are stored and encrypted in a vault or secure secrets manager within the system 100. On connection to the existing cloud account, the import handling engine 112 scans the cloud environment of the connected existing cloud account. The import scan is triggered by using at least one of: a manual trigger, a scheduled trigger, and triggered via a CI/CD integration. The import handling engine 112 detects the at least one active cloud resources and at least one service available in the cloud environment of the connected existing cloud account. The import handling engine 112 automatically generates a list of the at least one active cloud resources and the at least one service available in the cloud environment in an organized, a searchable format, and grouped by at least one of: a region, a service type, and at least one project tag. The import handling engine 112 stores the list of the at least one active cloud resources and the at least one service available in the cloud environment an inventory in the database 130.

In an embodiment herein, the import handling engine 112 may analyse the imported cloud resources. The import handling engine 112 may receive a request to map the imported resources from the user 302. The import handling engine 112 may receive a selection of the cloud resources from the inventory to be imported. A read only access permission is required during import, and at least one user credential is encrypted, and access follows least-privileged principles. When importing existing cloud resources, the import handling engine 112 does not create, update, or delete infrastructure at this stage. The import handling engine 112 only needs to read the metadata about the resources for example, configurations, IDs, tags. The principle of least privilege means the import handling engine 112 is granted only the permissions the system 100 strictly needs to import the cloud resource from the existing cloud account, and nothing more. According to the principle, only the minimum required permissions should be granted. Therefore, the import handling engine 112 may operate with basic read-only access to ensure security and limit unnecessary privileges. For import, a scope is defined for read only actions, access may be limited to only the relevant cloud accounts or regions, and a temporal control is granted to the system 100 which is optionally time-bound with temporary credentials or session-based roles.The import handling engine 112 may automatically may map using the at least one artificial intelligence technique by the AI handling engine 126 the analysed imported cloud resources into the visual high-level design (HLD) diagram by visually organizing the imported cloud resources.

In an embodiment herein, the import handling engine 112 automatically links the at least one active cloud resources and the at least one service available in the cloud environment to each other based on the logical relationship between the imported at least one active cloud resources and the at least one available service on the system 100, through the AI handling engine 126, and then creates into the visual high-level design (HLD) diagram by visually organizing the imported cloud resources.

In an embodiment herein, the import handling engine 112 may identify automatically, at least one gap and at least one redundancy in the mapped diagram using the at least one artificial intelligence technique by the AI handling engine 126. The AI handling engine 126 may compare the connections in the created diagram with the pre-trained logical and visual connection of the cloud resources. The import handling engine 112 may highlight at least one area in the infrastructure as a diagram (IAD) with at least one gap and the at least one redundancy in the mapped diagram that needs optimization.

In an embodiment herein, the system 100 may enable the user 302 to extend or modify the infrastructure as a diagram (IAD)using the architecture builder engine 404 and the AI handling engine 126, by receiving the query in natural language as disclosed in FIG. 4. The created infrastructure as a diagram (IAD) is then validated for misconfigurations, compliance issues, or inefficiencies (explained in FIG. 12). The system 100 generates the costing of the cloud infrastructure created according to the changes in the infrastructure as a diagram (IAD) (explained in FIG. 10). The HLD diagrams created using the import handling engine 112 can be reused or redeployed components as part of new workflows. The import handling engine 112 makes onboarding existing infrastructure effortless. The import handling engine 112 reduces rework, gain visibility into current cloud usage, and optimizes workflow.

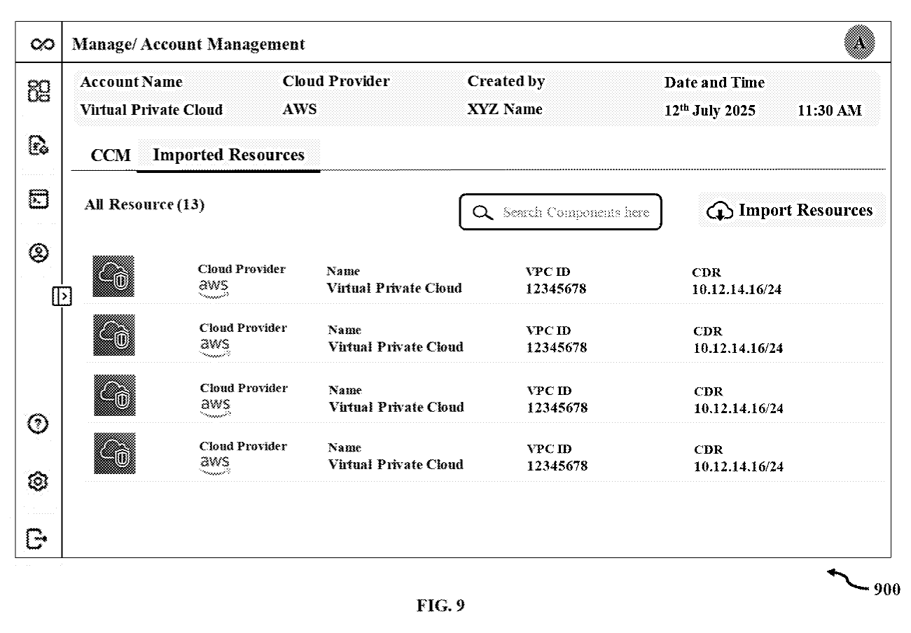

FIG. 9 shows an example screenshot 900 showing the import data handling engine 112, according to embodiments as disclosed herein. The import handling engine may display the imported cloud data on the visual interface 128 as shown in FIG. 9. The imported cloud data displayed may include the cloud account name. The imported cloud resources may be listed one by one in a listed view. The listed view may contain the cloud resources with the import date, cloud provider name, the resource identity, and the like.

FIG. 10 shows a block diagram 1000 illustrating an operation of the price information handling engine 116, according to embodiments as disclosed herein. The price information handling engine 116 in the system 100 estimates the cost of the infrastructure as a diagram (IAD)created to help user 302 make informed, cost-conscious decisions while planning and deploying cloud infrastructure. The price information handling engine 116 embeds real-time pricing directly into the architecture workflow.

In an embodiment herein, the price information handling engine 116 may estimate live, contextual pricing as the system 100 receives the input of the at least one cloud component, for example, compute, storage, databases, VMs, databases, load balancers, etc. As soon as the system 100 receives the add or modify the component in the architecture diagram, the price information handling engine 116 initiates a cost calculation, there is no requirement of instance types, regions, or storage sizes. Each of the at least one component is assigned a base price or a cost of the component. Every of the at least one component shows its per-hour and per-month cost, and is updated as a size of the component is changed or a region is changed. The system 100 enables display of the price estimation on the virtual interface. The costs may appear instantly next to each cloud resource icon or on a floating summary panel on the virtual interface 130, so the user 302 sees the price impact according to the design choices made in the diagram. For example, the EC2 component price is $20.16 for one item, the VPC component price is $25.20 for one item, and RTB component price is $16.80, the total cost estimate for the architecture is $62.16 per week. The administrative user 308 may have set a per-month cost for example, $1000, and a per-year cost as $ 40,000. If the cloud infrastructure cost for a month nears $1000, for example $960, a warning and alert will be generated, that the budget is reaching the soft budget. If the total cloud infrastructure exceeds the project budget for the year that is if it exceeds $40,000 the deployment is blocked.

In an embodiment herein, the price information handling engine 116 may perform a real-time price fetching by polling the cloud environments for example, AWS, Azure, and GCP pricing APIs at configurable intervals (For example, every 6 hours) to pull in the latest list and spot prices. The price information handling engine 116 caches the prices locally to avoid rate limits and latency, but automatically invalidated once the refresh window elapses. When the system 100 fetches the pricing data (from AWS, Azure, GCP, etc.), it stores that data temporarily to avoid fetching the same data over and over again, which would slow things down or exceed API limits. But that the cached pricing data is only valid for a limited time called the refresh window (for example: 6 hours, 12 hours, or 24 hours). Once that time is up i.e., once the refresh window “elapses” (ends) the system automatically invalidates the cached data. The price information handling engine 116 may ensure prices reflect the latest regional or provider-specific updates, discounts, or changes.

In an embodiment herein, the price information handling engine 116 may dynamically change the pricing of the components based on a change in instance size, region, storage class, or network configuration immediately reflecting in the pricing. The price information handling engine 116 may understand a context of deciding the pricing. The price information handling engine 116 may adjust the costs of the components and the total cost automatically adjust if the resource is moved from a first region to a second region based on regional price differences. For example, the pricing changes when the region is changed from us-east-1 to europe-west1. The price information handling engine 116 may include tiered pricing effects (e.g., data transfer tiers, reserved-instance discounts).

In an embodiment herein, the price information handling engine 116 may generate a running total. The price information handling engine 116 may recalculate monthly estimates and overall estimates as the design evolves giving real-time financial impact visibility. The price information handling engine 116 may generate a subtotal of the diagram by generating group costs of components in one group for example generating group costs by grouping components by compute, storage, networking, etc. The price information handling engine 116 may enable the user 302 to switch between recurring monthly rates and total cost over the project’s planned lifespan (e.g., 1 year, 3 years).

In an embodiment herein, the price information handling engine 116 may enable the users 302 to set the hard budgets or the soft budgets on projects to maintain cost discipline. In an embodiment herein, the administrative user 308 may set the hard budget or the soft budget while creating the new project. For example, 10,000 per month. price information handling engine 116 may generate threshold alerts. The threshold alerts are triggered when cost estimates reach a warning level (e.g., 80% of budget cap) or exceed the budget cap. If the estimated cost goes beyond the budget, the system 100 may require the managerial or the financial approval before deployment can proceed. A governance first approach integrates cost control into the early phases of the project diagram implementation not just after deployment.

In an embodiment herein, the price information handling engine 116 may perform a predictive "what-if" cost simulation using the AI handling engine 126 that adjusts budget alerts dynamically. the price information handling engine 116 may allow users 302 to explore hypothetical infrastructure changes and instantly see how the changes in the diagram would impact overall cloud costs before actually deploying the cloud infrastructure. The system 100 may receive the input of the alternative cloud component, and the user 302 may provide different numbers of components to simulate what-if scenarios. The received input may be increasing instance sizes, changing regions, switching storage classes, and adding redundancy (e.g., load balancers, backups). The price information handling engine 116 may perform a predictive "what-if" cost simulation by analysing the changes and estimating the costing for each change. The price information handling engine 116 may provide real-time cost feedback by displaying how these changes would affect. For example, the monthly cloud spends, the resource-specific costs, and the total budget consumption. The price information handling engine 116 may provide the budget alert thresholds if a simulated change pushes the project over budget, the system 100 adjusts the cost accordingly. For example, if a user 302 simulates scaling out 10 more VMs, the system might change an alert from "Warning" to "Critical." The what if simulations help teams plan proactively, prevents accidental overspending, supports better decision-making by showing trade-offs between cost and performance.

In an embodiment herein, the price information handling engine 116 may provide smart cost optimization recommendations that reduce the expenses by suggesting alternate configurations.The price information handling engine 116 may review the created cloud architecture and automatically suggests more cost-effective configurations without compromising core functionality. For example, instance right-sizing: recommends smaller VM sizes if a current usage is low, reserved instances or savings plans: suggests cost-saving alternatives for long-term workloads, storage tiering: recommends moving infrequently accessed data to cheaper storage tiers (e.g., from S3 Standard to S3 Glacier), regional optimization: Suggests cheaper regions with similar capabilities, and underutilized resources: identifies idle or low-use resources that can be shut down or consolidated. The price information handling engine 116 may leverage usage analytics, pricing APIs, and architecture patterns to evaluates performance needs versus resource allocation. The price information handling engine 116 may use a machine learning or a rule-based heuristics in the AI handling engine 126 to offer targeted recommendations. This encourages cost-efficient architecture design.

In an embodiment herein, the price information handling engine may display the price estimation on a pricing dashboard 1002. The pricing dashboard 1002 may summarize and display the overall project cost. The pricing dashboard 1002 may be displayed on the virtual interface 128. The pricing dashboard 1002 may display the cost break down by the cloud resource type. For example, the costing for compute, storage, and networking may be displayed separately. The pricing dashboard 1002 may display costing according to groups by project, environment (e.g., development stage, staging, or deployment), or resource group. The pricing dashboard 1002 may display real-time updates based on the changes in the diagram. The pricing dashboard 1002 may display cost comparisons across architecture versions Useful for reviewing how changes in infrastructure design impact pricing especially valuable during optimization or migration decisions.

In an embodiment herein, the price information handling engine 116 may export the cost estimates for review or reporting purposes in multiple formats. For example, the cost estimates may be exported in a CSV format for spreadsheet-style analysis or importing into other systems and for raw data manipulation such as resource type, configuration, region, unit price, quantity, total price. The cost estimates may be exported in an Excel format for custom calculations or charts. The excel format may have prebuilt pivot tables and charts so analysts can break down complex data into smaller parts to view it from different perspectives without rebuilding formulas. The cost estimates may be a PDF format for formal sharing with stakeholders or budgeting reviews, The PDF format may be exported for executive-style one-pagers with top-level costs, budget status, and selected architecture diagrams.

In an embodiment herein, the price information handling engine 116 may generate the alert when cost estimates reach warning or critical thresholds. The price information handling engine 116 may generate the alert on breaching a soft budget limit set by the user 302 to warn the user 302 without blocking any further change in the cloud infrastructure diagram. The price information handling engine 116 may generate the alert on breaching the hard budget limit set by the user 302 to warn the user 302 and blocking any further change in the cloud infrastructure diagram and the deployment of the diagram until an approval received from an authorized approver. When thresholds are exceeded, the price information handling engine 116 may initiate the workflow for financial or managerial approval before proceeding with deployment. The financial or managerial approval adds an additional layer of accountability and governance.

In an embodiment herein, the price information handling engine 116 may utilize the secure API connections that are authenticated and encrypted connections to access pricing data from the cloud providers. The price information handling engine 116 may refresh the cost estimates by updating the pricing on a regular schedule to reflect the latest market and provider changes to maintain accuracy. The cost-related data is encrypted and access-controlled based on the user roles. The pricing data, estimates, and exports are securely stored and access-controlled. the price information handling engine 116 may enable only authorized users 302 (e.g., finance team or project owners) can view or modify pricing details.

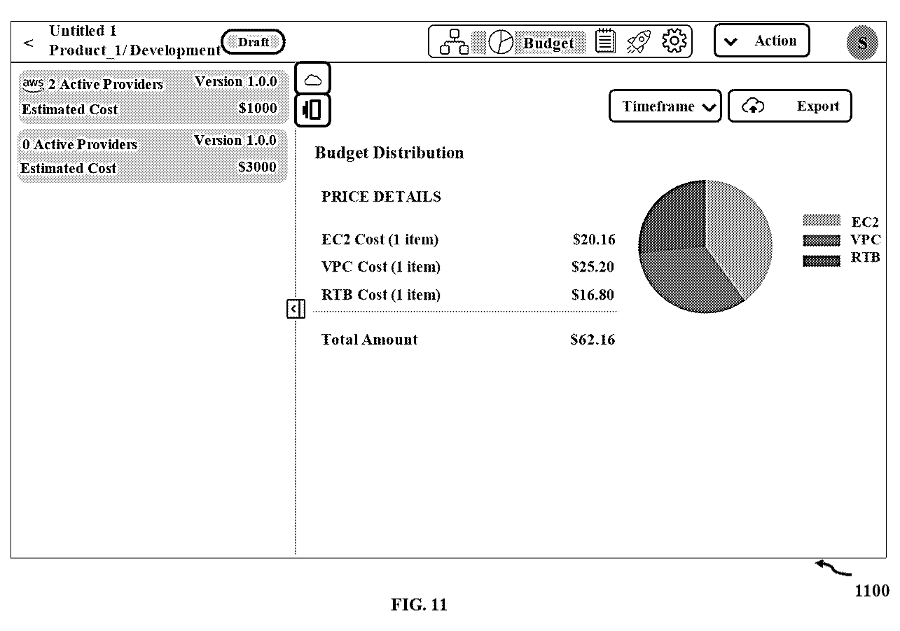

FIG. 11 shows an example screenshot 1100 of the price handling engine 116, according to embodiments as disclosed herein. The pricing dashboard 1002 may display the price estimates. A pie chart or any chart may be generated and displayed on the price dashboard 1002 showing the comparison of the prices of components.

FIG. 12 shows a block diagram 1200 illustrating an operation of the validation handling engine 118, according to embodiments as disclosed herein. The validation handling engine 118 automatically checks for errors and ensures that the infrastructure as a diagram (IAD) follows best practices, the infrastructure as a diagram (IAD) is complete and consistent, and the infrastructure is ready to be deployed without failure. During creating the infrastructure as a diagram (IAD) using the architecture handling engine 110, the validation handling engine 118 immediately checks automatically if the at least one component is configured correctly in the infrastructure as a diagram (IAD), if the at least one component is connected logically, if any dependencies are missing. The validation handling engine 118 performs a final pass to ensure everything is production-ready just before deployment by checking if the at least one component in the infrastructure as a diagram (IAD)is properly linked to the other at least one component. The validation handling engine 118 checks for if the required parameters (for example, region, size) are filled. The validation handling engine 118 checks if any cross-cloud or policy violations exist.

In an embodiment herein, during periodic scans or updates the validation handling engine 118 checks automatically on a scheduled basis (e.g., weekly or monthly) and re-validates the architecture and detects drift for configuration changes not reflected in design and identifies deprecated services or outdated configurations. The validation handling engine 118 ensures that errors are caught early, during building the diagram, editing, or preparing to launch. Validation is useful for ongoing governance, especially in long-running or collaborative projects. These validation checkpoints ensure continual architecture hygiene, not just a one-time pass.

In an embodiment herein, the validation handling engine 118 checks for a wide range of misconfigurations and mismatches, including:

Cross-cloud mistakes: The validation handling engine 118 recognizes errors that combine services from incompatible cloud providers in ways that won’t work or aren’t supported. The validation handling engine 118 detects connections or addition of the cloud components from more than one cloud environments. For example, connecting an AWS Lambda (serverless compute) directly to an Azure SQL Database — which would fail due to latency, an authentication incompatibility, and unsupported integration patterns. The validation handling engine 118 flags the detected errors and often suggests alternative patterns and suggest bridge solutions like API Gateways or data replication strategies (e.g., use cloud-native equivalents or enable API gateway access).

Missing configurations: The validation handling engine 118 tracks mandatory properties for each cloud service and for each cloud component. The validation handling engine 118 may check dependencies of the components added in the infrastructure as a diagram (IAD) as the cloud resources require dependencies or network placement to function properly. Examples of missing elements are a virtual machine (VM) without a network interface or subnet, a Lambda function missing an IAM execution role, and an S3 bucket without a region or access control settings. The validation handling engine 118 validates whether all required configurations are in place for each service and prevents incomplete definitions from progressing. If something critical is missing (like a required network config or IAM role), the validation handling engine 118 flags the issue and recommends defaults or asks for manual correction.

Invalid or conflicting inputs: The validation handling engine 118 checks for unsupported instance types, wrong port numbers, or incompatible tiers in the infrastructure as a diagram (IAD). The validation handling engine 118 ensures all values conform to cloud provider constraints and best practices: The validation handling engine 118 checks if any instance type not available in the chosen region is selected, if the user 302 is using ports outside the allowed range or blocked by firewalls, or a “Standard” storage class is assigned to a high-performance production DB that requires “Premium.” The validation handling engine 118 checks service specifications against real-time cloud data to ensure validity. For example, the validation handling engine 118 detects choosing a storage tier that’s not available in the selected region, entering a port number outside the valid range (e.g., 99999), using an unsupported instance type for a selected OS or workload. The validation handling engine 118 compares the input of the cloud comment against real-time cloud provider specs (fetched via APIs) and compatibility rules (e.g., GPU instances only in certain zones). The validation handling engine 118 flags the issues detected with contextual help to guide quick fixes.

Three-tier architecture gaps: The validation handling engine 118 detects missing pieces (e.g., missing database layer, no load balancer for web tier) based on typical design patterns. For example, the validation handling engine 118 checks a Web Tier for a load balancer, an App Tier for compute layer connected to a front and a back end, or a database Tier for a database configured, secured, and linked. If any part of this pattern is missing or improperly configured, the validation handling engine 118 flags the design gap and suggests appropriate components to fill the gap. The validation handling engine 118 helps enforce best practices and avoid fragile or broken deployments.

The validation handling engine 118 performs dependency and constraint validation in the created diagram. The validation handling engine 118 checks service dependencies against what cloud providers allow. For example, ensuring a service can operate in a selected region or within specific limits. The validation handling engine 118 checks rate limits and resource caps (e.g., max number of VMs or IP addresses) are verified to prevent hard failures during provisioning. For example, the validation handling engine 118 prevents dependency and constraint validation by querying the cloud provider APIs to get: the current usage of the system. (e.g., already running 18 out of 20 allowed VMs). The validation handling engine 118 may also retrieve the account quotas and limits (e.g., 20 VMs allowed per region) and the simulates the architecture to be deployed, and determines the number of resources the deployment will consume (e.g., +6 VMs, +4 IPs). The validation handling engine 118 may compare the usage of the requested component against the set limits. If the infrastructure as a diagram (IAD) exceeds the set limits, the validation handling engine 118 raises a pre-deployment validation error and provides suggestions (e.g., reduce instances, request quota increase).

In an embodiment herein, the validation handling engine 118 may perform cost constraint validation by checking the estimated budget of the created diagram against the set budget. If the diagram exceeds the allocated budget, the validation handling engine 118 blocks deployment. The validation handling engine 118 may suggest possible optimization like switching instance types or resizing storage to maintain the budget of the diagram within limits.

In an embodiment herein, when the validation fails, the validation handling engine 118 displays the error instantly with the required suggestions and fixes. In critical cases such as an invalid design or over budget), the validation handling engine 118 may block the deployment. In case of normal warnings or soft constraints, users 302 get recommendations, and deployment is not blocked.

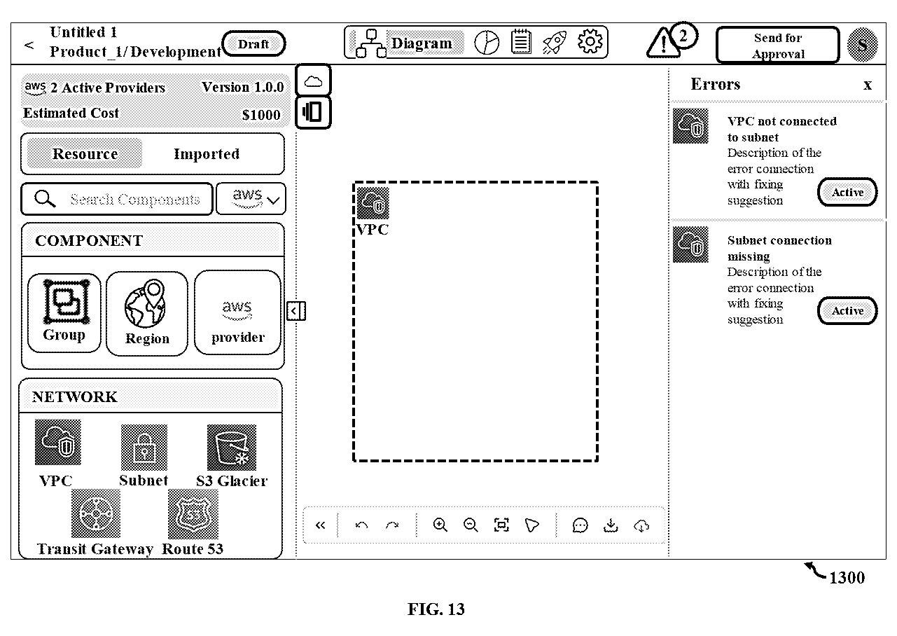

FIG. 13 shows an example screenshot 1300 illustrating the validation handling engine 118, according to embodiments as disclosed herein. A user 302 may access the validation report from a side bar panel on a screen of the virtual interface 128. On accessing the validation panel on the side bar, the sidebar shows all the validation that is run automatically by the validation handling engine 118 along with a status report on the side. For example, connection misconfiguration between the VM and the network entity is Active.

FIG. 14 shows an overview block diagram 1400 of the version handling engine 120, according to embodiments as disclosed herein. By using the version handling engine 120, the users 302 can access the full history of versions for each architecture. The users 302 can submit the latest version for the approval. The system 100 (or system) automatically creates a new version whenever a user 302 make changes, submits for approval, updates or deploys the configuration. The user 302 can compare two versions side-by-side to view differences in added components, settings and budget changes

The version handling engine 120 maintains the version history having a chronological log of a version of the infrastructure as a diagram (IAD)of the cloud architecture. The user 302 may manually save each version for a future reference. Each version is saved with a timestamp and a tag with the user identity. The user identity may be associated with the creator, the modifier, and the approver. The version handling engine 120 enables the user 302 to perform a comparison in between the version selected for tracking changes, a difference in the budget estimate, and the deployment integration. The version handling engine 120 generates at least one audit log and at least one detailed change summary for every version. The version handling engine 120 supports roll-back mechanism by restoring a previous version on selecting to roll-back to a selected version to revert undesired changes. The version handling engine 120 may send a latest modified version automatically sent to a deployment pipeline. A deployed version is locked for any further changes. The version history and rollback feature may be accessible only to project members with a valid permission.

In an embodiment herein, the version handling engine 120 maintains a comprehensive version history. The version handling engine 120 may ensure that every change made to the infrastructure as a diagram (IAD) is tracked and preserved in a secure, tamper-proof log. Once a version is created, it cannot be modified or deleted, preserving the integrity of the diagram’s version history. Each version is saved with the exact date and time it was created or modified. The version handling engine 120 maintains a user attribution by recording who created or edited each version. For example, "John Doe modified this version on Jul. 10, 2025, at 14:03 UTC"). The version history may be saved with tags and messages. The users 302 can add labels (e.g., "initial draft", "budget finalized") to help categorize and search versions. Maintaining the comprehensive version history enables traceability and accountability in collaborative or regulated environments.

In an embodiment herein, the version handling engine 120 may assign access controls to each user 302. Each user 302 has different access and are not able to modify or even view version history. The version handling engine 120 enforces role-based access permissions. Role based access permissions enables managing user permissions in the system 100 by assigning users 302 to roles, and then granting permissions to those roles and not directly to individual user 304. Instead of giving user A, user B, and user C separate permissions one by one, roles like: admin, editor, viewer, and approver are created, and then the user A, user B, and user C are assigned the specific roles with permission assigned what each role is allowed to do. In an embodiment herein, logical groupings of permissions based on job function or responsibility may be created. For example, Project Manager, Developer, Finance Analyst. Permissions are the actions that roles are allowed to perform. For example, edit document, view budget history, restore version). Assigning roles and permissions prevents unauthorized actions. For example, only deployers can release code. Assigning roles and permissions helps to manage roles, not hundreds of individual user 304 permissions. Assigning roles and permissions enables easy scalability, that is easily add new users 302 by assigning them to existing roles. Assigning roles and permissions meets system compliance by Meeting standards like SOC 2, HIPAA, GDPR which require access controls.

In an embodiment herein, the version handling engine 120 may assign granular permission levels such as view-only, compare versions, restore versions, and delete or archive (if allowed). Access is limited to those explicitly added to the project with appropriate permissions. Audit compliance is maintained by maintaining logs who accessed version history and when, even if no changes were made. The version handling engine 120 protects sensitive data and prevents unauthorized rollbacks or changes.

In an embodiment herein, the version handling engine 120 may enable the user 302 to perform version comparison. The version handling engine 120 allows the user 302 to visually compare two versions of the project or the configuration file side by side. Each difference is highlighted to show the component-level differences. For example, added components are marked in green, removed components are struck through or marked in red, modified components show both old and new values. Also, configuration differences are highlighted. For example, shows parameter changes (e.g., timeout: 30 → 45). Comparison also shows budget comparison by highlighting changes in cost estimates, line by line or in summary. The version handling engine 120 may utilize visualization tools on the virtual interface 128 to show the comparison between versions. The visualization tools may include syntax highlighting, collapsible views, or charts for complex comparisons. Comparison helps reviewers or managers quickly understand what has changed without manually scanning documents.

In an embodiment herein, the version handling engine 120 ensures smooth transition from development to production with automatic and secure deployment handling. The most recent approved version is pushed to the deployment pipeline without manual intervention. In an embodiment herein, the version handling engine 120 may perform version locking: Once a version is deployed, the version cannot be modified. If there are any fixes, the fixes must be made in a new version. In an embodiment herein, the version handling engine 120 maintains deployment consistency and prevents last-minute, untracked changes.

In an embodiment herein, the version handling engine 120 maintains audit logs and change summaries. This feature automatically documents what changed and why, for future reference or compliance needs. The audit logs are maintained with a record of every action taken, including who changed what (role and the change made), when the change was made (timestamp), the version name that was affected by the change. In an embodiment herein, the version handling engine 120 maintains auto-generated summaries that highlight key modifications including file difference, updated parameters, and budget details. The version handling engine 120, may export reports in formats like PDF, DOCX, or CSV. Generating version reports and audit logs supports internal reviews, stakeholder reporting, and external audits (e.g., ISO, SOC 2, HIPAA).

In an embodiment herein, the version handling engine 120 may provide restore options to revert or rollback to the last stable version. Sometimes mistakes happen in a version. The restore and roll-back feature lets teams revert to a previous version easily. The version handling engine 120 may receive a click-to-restore input to revert or a request to roll-back to a selected version without needing to manually reapply changes. The version handling engine 120 may receive a selection of the version that needs to be restored. The rollback to any historical version can be made based on a timestamp or tag. The version handling engine 120 only allows users 302 with the permissions to initiate roll-back to access the restore options. All the roll-backs or restorations are logged like any other change, for restoration traceability for preserving transparency. Restoration minimizes a system downtime and a human error by enabling rapid recovery from missteps or failed experiments.

In an embodiment herein, the version handling may be done automatically. The version handling engine 120 automatically tracks, saves, and manages changes to the files, documents, codebases, the configurations, or the projects without requiring users 302 to manually save new versions. Automatic version handling ensures that every significant change is captured as a new version, stored in a structured way, easily searchable, and enables safe roll-back to the previous version if needed.

In an embodiment herein, version handling engine 120 tracks the diagram files, the code, or documents for modifications in real time. This can be continuous (watching file systems or databases) or triggered by user actions (like saving, committing, or deploying). The version handling engine 120 creates the new version automatically when a change is detected. The version handling engine 120 saves the new version with the changed content, the timestamp, the user 302 who made the change, the difference of what changed compared to the last version. Each version is tagged with descriptive labels (e.g., “config-update”, “Q3 budget”). The version handling engine 120 may autogenerate summaries using the AI handling engine 126.The versions are saved in a secure, indexed repository. The storage of the versions may include content hashing to avoid duplicates and enable delta storage (store only the difference, not the full copy). The version handling engine 120 enables the users 302 can search for versions by keyword, author, date, or type of change. Versions can be visually compared side-by-side to understand what changed. Any previous version can be restored instantly. The system 100 may also allow partial rollbacks (restore just a component or setting). The version handling engine 120 enables precise tracking, management, and restoration of architecture designs with per-component versioning, ensuring detailed history, easy comparisons, and reliable rollback.

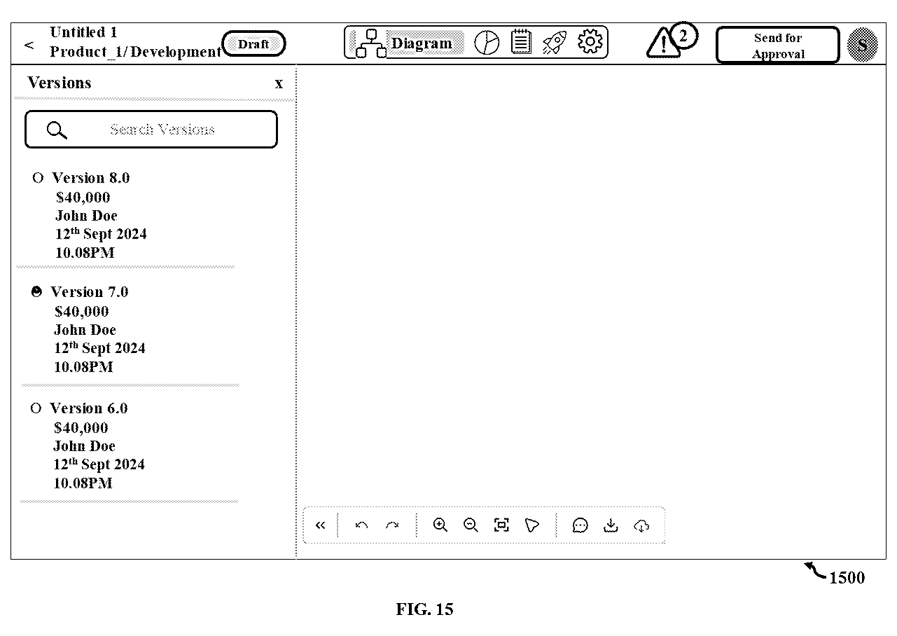

FIG. 15 is an example screenshot 1500 illustrating the version handling engine 120, according to embodiments as disclosed herein. During creating, editing or modifying the HLD diagram on the canvas page, the virtual interface 128 displays a version panel. The version panel displays all the saved versions of the HLD diagram with proper timestamp besides a version name. From the version panel, a user 302 may send a selected version, in case of a rollback required to the selected previous version. The user 302 may select a number of versions for a comparison of versions. Each of the version may be displayed in a side-by-side view, showing all changes highlighted using at least one marker in the canvas page. For example, addition of a component, the component is marked in green, a deleted component is marked in red.

FIG. 16 shows an overview block diagram 1600 of the approval handling engine 122, according to embodiments as disclosed herein. The approval handling engine 122 may receive at least one approval request from the user 302. The user 302 may have submitted at least one of: the infrastructure as a diagram (IAD) for the cloud architecture, the budget plan, and the security configuration for approval. The at least one approval request includes at least one shareable diagram file in at least one file format in an editable hyperlink having a path for the diagram file, an image, and a document. The at least one approval request is routed through a defined approver channel according to a configured role and hierarchy.

In an embodiment herein, the approval handling engine 122 governs and automates review and authorization processes for the architecture designs, the budget proposals, and the security compliance to ensure governance, the financial control, and the organizational policy adherence before deployment. The approval handling engine 122 may forward the approval request to the defined approvers. There may be three types of approvers: architecture approvers, finance approvers, and security approvers. The architecture approvers may review and approve cloud architecture designs and modifications. The architecture approvers may validate compliance with organizational and technical standards. The Finance Approver may evaluate budget proposals for cost-effectiveness and policy compliance. The finance approver may approve or reject budget requests based on financial feasibility. The security approvers may assess security compliance of architecture and configurations. The security approvers may approve only those submissions passing automated security scans and policy checks.

In an embodiment herein, the approval handling engine 122 may follow an approval workflow and hierarchy. The approval workflow and hierarchy are a structured process used to manage and authorize decisions, requests, or tasks for approving the approval requests. The hierarchy defines who needs to approve what, in what order, and under which conditions. The workflow outlines the sequence of steps the approval request must go through, while the hierarchy identifies the levels of authority involved such as team leads, managers, or executives.

The approval handling engine 122 ensures that important actions like the architecture designs, the budget proposals, and the security compliance are reviewed by the right people. The approval handling engine 122 helps maintain accountability, reduces risks, and enforces compliance with company policies. Approval workflows can be simple (single-level) or complex (multi-tiered), and the approval workflow may operate sequentially or in parallel depending on the business needs. When customized properly, the approval workflow improves transparency, decision-making speed, and operational efficiency.

In an embodiment herein, the approval handling engine 122 supports highly granular and customizable roles, enabling alignment with specific organizational structures and governance policies. Permissions may be broken down into fine levels of control. For example, one user 302 can view requests but not comment, while another can comment but not approve. The roles may be assigned based on user type, a department, a project, or a level of authority. Each role carries explicit permissions that determine access and actions within the workflow. For example, some users 302 may only have permission to view approval requests, ensuring visibility without the ability to act. Others may be designated as approvers, giving them the authority to approve or reject submissions. Additional roles can allow users 302 to add comments, suggest revisions, or request changes to the submission. The permissions can also be conditional, activated only for certain projects, thresholds, or request types. The approval handling engine 122 ensures sensitive approvals are handled only by authorized individuals with the correct responsibilities. The detailed control enhances security, compliance, and operational efficiency across teams.

In an embodiment herein, the approval handling engine 122 may define parallel approval chains for approval. Multiple approvers may review and act on the approval request simultaneously rather than sequentially. Parallel approval chain significantly speeds up the overall approval process, especially in cross-functional teams. Each approval chain may be assigned to different roles or departments handling different concerns. For example, the architecture diagram may be approved by a technical lead, the budget approval may be approved by a finance lead, and the policy approvals are given by a high-level business compliance manager. Following the parallel approval chain enables decisions made independently in parallel, reducing bottlenecks. Once the approvals are received by the approval handling engine 122, the parallel approvals may be aggregated into a single final decision point or a final approval.

In an embodiment herein, the approval handling engine 122 may support a flexible multi-tier structure. The system 100 may have received input from the administrative user 308 to build multi-tiered approval paths that reflect real-world decision layers. For example, the budget approval might require team lead, finance, and executive sign-offs. Each tier can include conditions, such as the price thresholds or the project type. The system 100 may insert optional or mandatory steps depending on organizational governance needs. The multi-tier structure supports compliance-heavy industries and granular access control, and auditability across different user roles and organizational levels.

In an embodiment herein, the approval handling engine 122 enables the defined approvers to perform automatic scans for at least one of: the cloud architecture, the cloud management role, the network security, the encryption, and the backup policy per the organizational standard and the compliance framework. The approval handling engine 122 may block or flag at least one non-compliant request from approval.

The approval handling engine 122 may perform automated validation and checks.

Architecture Approval: Users 302 can submit architecture designs and budget plans for approval. Each request undergoes a defined approval workflow based on predefined roles and permissions. The approval handling engine 122 checks for submitted diagrams meet compliance frameworks and best internal practices. The system maintains a complete history of approvals, rejections, and comments for future reference.

Budget Approval: The system performs automated budget validation, ensuring the requested amount does not exceed pre-defined limits. Users 302 can submit budget proposals for new designs, modifications, or deployments. Approvers can review cost breakdowns, compare previous budgets, and assess financial feasibility.

Security Approval: Security approval ensures compliance with organization-wide security policies. The approval handling engine 122 supports an automated security scans to validate configurations against compliance standards. The approval handling engine 122 provides an access control settings (e.g., Identity and Access Management (IAM) roles, permissions), network security (e.g., firewalls, VPC settings), and data protection measures (e.g., encryption, backup policies or the like). Non-compliant requests are flagged for remediation before approval.

In an embodiment herein, the approval handling engine 122 enables the approvers to approve, reject, or request changes with comments. The approval handling engine 122 receives real-time comments and feedback on the diagram from the defined approver. The approval handling engine 122 may generate automated notifications prompting remediation and resubmission for rejected submissions.

In an embodiment herein, upon receiving the approval for the architecture, the budget, and the policy, the approval handling engine 122 may lock the at least one approved diagram for the cloud infrastructure for any further modification and change in budget and consider the at least one approved diagram as ready for deployment. The approval handling engine 122 may integrate the at least one approved diagram with a version history of the at least one approved diagram to ensure only an approved version progress to deployment.

In an embodiment herein, the approval handling engine 122 may track a status of approval for each of the approval request received. The approval handling engine 122 may receive partial approvals. For example, the architecture is approved but the budget is pending. The approval handling engine 122 manages the approval status through workflow status tracking. The approval workflow status tracking provides real-time visibility into the progress of the approval request or task within the approval process. The approval workflow status shows which steps have been completed, who has approved or rejected, and which approvals are still pending. Statuses like "Pending," "Approved," "Rejected," or "In Review" help users 302 and managers monitor progress. The workflow status tracking ensures accountability by recording timestamps and approver actions at each stage. Transparency in approval workflow improves decision-making, reduces delays, and helps resolve bottlenecks quickly.

In an embodiment herein, the approval handling engine 122 may save the audit log with an approval history securely for the compliance and the governance audit. The audit log comprises at least one of: a time stamp, a user identity, an action performed on the infrastructure as a diagram (IAD), and a comment. The approval handling engine 122 may store an approval metadata securely for compliance and governance audits. The approval handling engine 122 may store data related to approvals (metadata) like approver names, roles, dates, and outcomes. The data can be required during audits or investigations. The approval handling engine 122 ensures the organization meets legal, industry, and governance standards. The security measures like encryption, access controls of the system 100 protect sensitive information.

In an embodiment herein, the approval handling engine 122 may generate exportable audit logs of approval history and change logs for reporting and regulatory purposes. The approval handling engine 122 may generate detailed reports of past approvals and changes for internal or external use. The audit logs may be exported into formats like CSV or PDF for compliance checks or stakeholder reporting. Maintaining audit logs simplifies meeting regulatory and audit requirements. The approval handling engine 122 may apply custom filters and search options to help extract specific approval trails.

In an embodiment herein, the approval handling engine 122 may retain the records as per organizational data retention policies. The approval handling engine 122 keeps approval records for as long as the company’s policy requires. For example, finance-related approvals might need to be retained for 7 years. Retention settings can be customized per workflow or project. After the retention period, data can be archived or securely deleted as required.

In an embodiment herein, the approval handling engine 122 may generate a pending approval request alert for the at least one approval request if pending for approval from the defined approver. The approval handling engine 122 may generate an alert as a notification to the approver for the pending approval request. In case of overdue timings in approving the request, the approval handling engine 122 generates an escalation for overdue of approvals. The approval handling engine 122 re-routes the at least one approval request when an escalation is received for overdue of approvals to at least one of: a supervisor and an alternate approver.

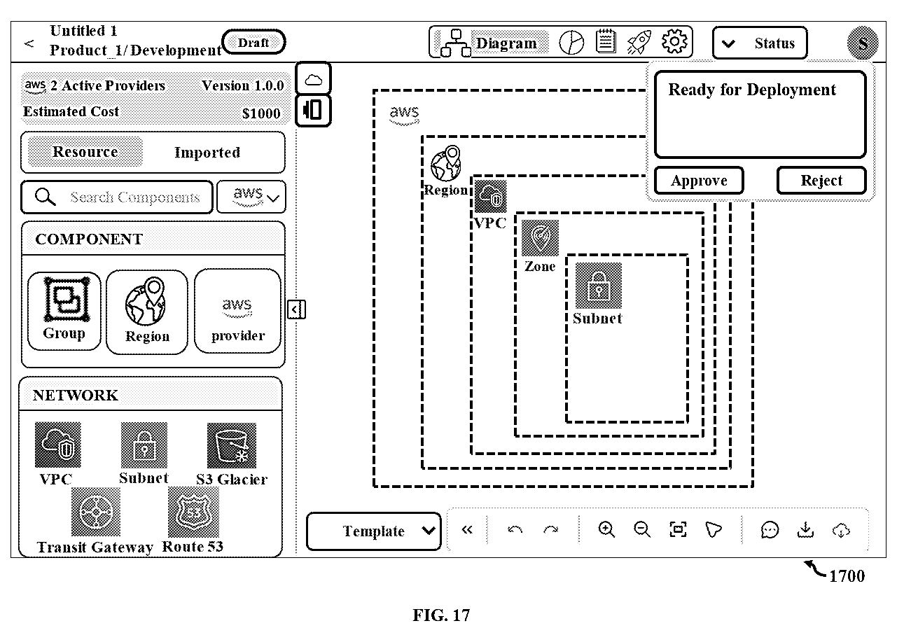

FIG. 17 shows an example screenshot 1700 illustrating the approval handling engine 122, according to embodiments as disclosed herein. The screenshot is of the dashboard on the virtual interface 128. The approver may be able to see the number of approval request as a list. On clicking on one of the approver requests, the virtual interface 128 may prompt the approver to approve or reject the approval request.

FIG. 18 shows a block diagram 1800 for the deployment handling engine 124, according to embodiments as disclosed herein. The deployment handling engine 124 is responsible for provisioning the cloud infrastructure and the services based on the approved architecture designs and budgets. The deployment handling engine 124 may receive the at least one request to deploy the at least one cloud architecture selected by the user 302 from the list of the approved cloud architecture. The deployment handling engine 124 may deploy by directly interacting with a cloud network 802 eliminating the use of infrastructure as a code and eliminating the use of a Continuous Integration and Continuous Deployment (CI/CD) pipeline. The deployment handling engine 124 supports a simple deployment process by receiving a deployment request as a click or any input from the user and directly start the deployment process for deploying the cloud architecture, making the deployment easy, fast, hassle-free without the use of CI/CD pipeline.

The deployment handling engine 124 ensures a streamlined deployment process with monitoring, rollback, and audit capabilities. Also, the deployment handling engine 124 supports parallel deployment of multiple components for faster provisioning.

In an embodiment herein, the users 302 select the approved architecture and trigger deployment. Pre-deployment validation compares the existing cloud environment with the intended architecture. Based on the comparison, the deployment handling engine 124 detects inconsistencies, conflicts, or redundant resources. Once resolved, the deployment handling engine 124 automatically provisions cloud resources, including, compute instances, storage, databases, networking components. The deployment is executed using system cloud (for example) and no IaC tools and no special CI/CD setup is needed.

In an embodiment here, the deployment handling engine 122 utilizes a customized data structure and the official cloud software development kit (SDK) for each of the cloud environment for deployment of the selected at least one cloud architecture. The customized data structure enables the system with the at least one cloud resource needed for deployment along with the sequence order of the at least one cloud resource to be deployed.

In an embodiment here, the deployment handling engine 124 may define the customized data structure. The customized data structure may be a structured file (usually in JSON) that describes the at least one cloud resource needed for deployment. The at least one cloud resource may be services, for example compute, storage, database; configurations, for example, machine size, region, OS; architecture for example, multi-tier, serverless; and dependencies for example, startup scripts, network rules.

In an embodiment herein, each cloud component in the cloud architecture is stored as a JSON object. During deployment, the deployment handling engine 124 retrieves all configurations, identifies the relationships between the components, and then makes the necessary cloud API calls to provision the infrastructure.

In an embodiment here, the deployment handling engine 124 may parse and validate the customized data structure. The deployment handling engine 124 may scan, read and validate the customized data structure. The deployment handling engine 124 may ensure required fields exist (for example, project ID, instance name). The deployment handling engine 124 may check for valid resource names. The deployment handling engine 124 may verify that configurations are compatible (for example, correct machine type for region)

In an embodiment here, the deployment handling engine 122 may authenticate with the cloud provider environment before utilizing the cloud software development kit. The authentication may be done using credentials (service account key, access token, or CLI login), through SDK authentication methods, and use the cloud SDK to provision resources. The parsed configuration is passed to SDK functions that call the cloud API to create the resources.

In an embodiment here, the deployment handling engine 122 may generate a real time summary of the at least one cloud resource either created, modified and deleted. The deployment handling engine 122 is responsible for managing the lifecycle of cloud resources during deployment. The deployment handling engine 124 may generate a real-time summary to track the status of at least one cloud resource that is created, modified, or deleted during the process. The summary includes key metadata such as resource name, type (e.g., VM, storage), operation performed, timestamp, and status (success/failure). The summary helps in monitoring, logging, and auditing deployments across different environments. The summary may be visualized through dashboards in real time or stored as structured logs. Real-time generation ensures prompt visibility and quick error detection during deployments.

In an embodiment here, the deployment handling engine 122 may generate an execution graph to determine the sequence order of the at least one cloud resource to be deployed. The deployment handling engine 122 analyzes the infrastructure defined in the customized data structure file. Then the deployment handling engine 122 builds an execution graph, where each node represents the cloud resource (e.g., VM, VPC, database). The edges of the graph define dependencies between resources (e.g., a VM needs a network to exist first). The deployment handling engine 122 determines which operations can be executed in parallel (e.g., creating databases and VMs simultaneously) using the execution graph. The deployment handling engine 122 may identify which operations must occur in sequence, like setting up the VPC before deploying the EC2 instances that depend on it. The execution graph prevents race conditions and failed deployments due to missing dependencies. Each node in the graph is mapped to specific SDK calls using official cloud SDKs (e.g., AWS SDK, Google Cloud SDK). The engine follows the chronological order of the execution graph to execute tasks in the correct order. For example, it may first create the network, then provision compute resources, and finally deploy applications. The deployment handling engine 122 may use asynchronous calls and task queues to handle parallel operations efficiently. The deployment handling engine 122 may also implement retry logic and error handling per node to prevent complete deployment failures. The deployment handling engine 122 may update the status (e.g., "created", "failed") in real-time, as each resource is processed. The deployment handling engine 122 may perform optimizations like batching and region-aware deployments are applied to reduce latency and cost. Execution graph ensures a safe, efficient, and scalable deployment process. Execution graph ensures complex cloud infrastructures are provisioned accurately and consistently across environments.

In an embodiment herein, the deployment handling engine 122 may check and validate in real time during the deployment process for a discrepancy in deployment. The discrepancy in deployment may include, but is not limited to at least one of: a conflict, a duplication of the cloud resource, an unsupported configuration, and misaligned dependencies of the cloud components. An unsupported configuration refers to cases where required settings for the at least one component, for example, a VPC is not provided or configured correctly. For example, if a VPC requires specific parameters and they are missing or misconfigured, it results in an unsupported setup. The deployment handling engine 122 may generate a prompt to fix the discrepancy before proceeding further with the deployment.

In an embodiment herein, the deployment handling engine 122 may generate a log of the deployment process to show per-component progress in real time deployment. The deployment handling engine 122 may store the generated log in the database 130. The progress comprises at least one of: a success and a failure in real-time. In case of a failure in deployment, the failure steps are highlighted, and options for retry deployment and a version rollback are given immediately.

In an embodiment herein, the deployment handling engine 124 may generate a locked version snapshot, capturing the full deployment state, on every deployment. A locked version snapshot is a frozen, read-only record of a deployment at a specific point in time. The locked version snapshot captures all the essential information required to understand, audit, and reproduce that deployment exactly as it occurred. The locked version snapshot includes the full deployment configuration, such as resource definitions and parameters. The locked version snapshot contains cost estimates to predict cloud usage charges. The locked version snapshot contains a change list details, disclosing exactly what will be created, modified, or deleted. The snapshot is immutable, meaning it cannot be altered ensuring reliable audit trails and compliance. If any part of the deployment fails, the deployment handling engine 124 automatically detects a failure point using the snapshot. On detecting the failure, the deployment handling engine 124 may trigger a guided rollback, undoing only the changes made during that session. Alternatively, the deployment handling engine 124 may allow the users 302 to retry specific components without restarting the entire deployment. The guided rollback improves reliability and saves time during recovery or debugging. The combination of snapshots and rollback ensures safe, repeatable, and traceable deployments.

In an embodiment herein, the deployment handling engine 124 may allow to schedule deployments at specific times to align with business needs or low-traffic hours, reducing risk and disruption. Scheduled deployments ensure updates or infrastructure changes happen during optimal windows. Scheduled deployment also supports automatic scaling, where resources are scaled up during periods of high demand to maintain performance and availability. Conversely, during idle or low-traffic periods, the system 100 scales down unused or underutilized resources to save costs. Scaling up and scaling down is typically managed through monitoring tools, auto-scaling policies, or predictive AI techniques. Scheduled tasks and scaling actions are logged for audit and traceability. These features help optimize resource usage, reduce operational overhead, and maintain a balance between performance and cost-efficiency.

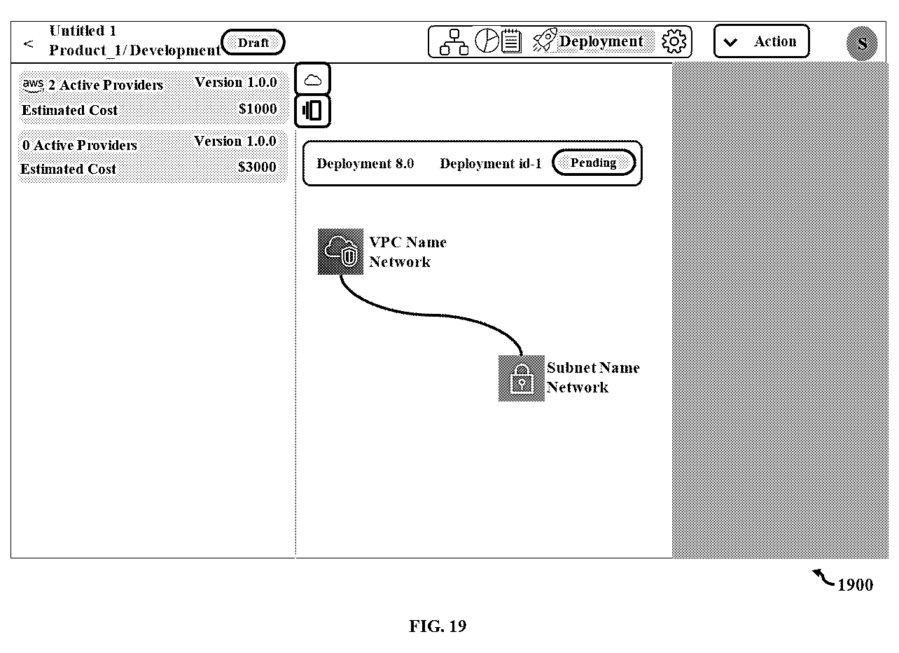

FIG. 19 shows an example screenshot 1900 illustrating the deployment handling engine 124, according to embodiments as disclosed herein. The screenshot shows the screenshot of the display on the virtual interface 128. The virtual interface 128 shows a real time status of deployment with the data of which component is deployed at what time.

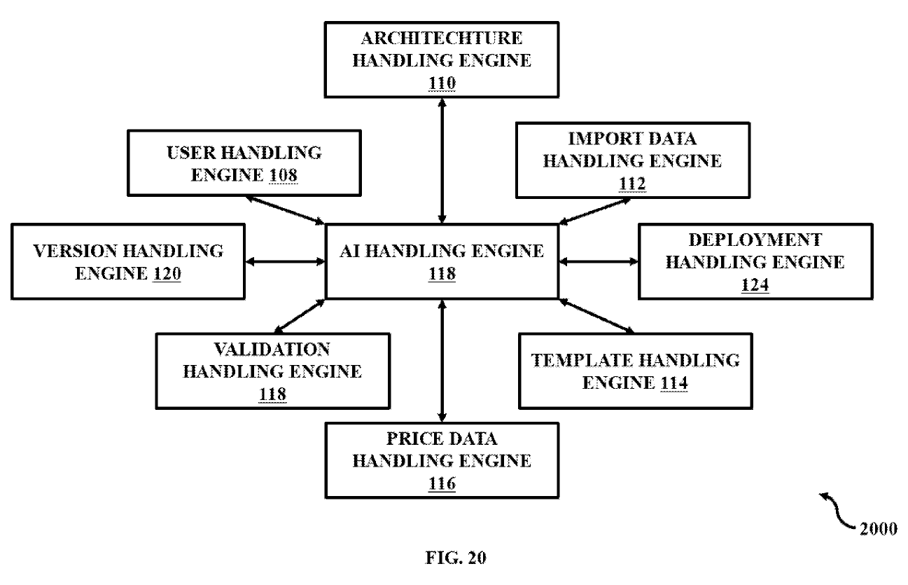

FIG. 20 shows a block diagram 2000 for the AI handling engine 126, according to embodiments as disclosed herein. The AI handling engine 126 may be in communication with at least one of the user handling engine 108, the architecture data handling engine 110, the template handling engine 114, the import handling engine 112, the price information handling engine 116, the validation handling engine 118, the version handling engine 120, and the deployment handling engine 124. The AI handling engine 126 may help in creating the HLD diagrams by receiving the query, preprocessing the query and generating the HLD diagram. Based on the user prompts, the AI handling engine 120 analyses cloud resources and automatically creates the High-Level Design (HLD) diagram. Further, the AI handling engine 120 uses the predefined best practice for each cloud provider (e.g., AWS, Azure, GCP, etc.,). Further, the AI handling engine 120 arranges components logically and optimizes resource placement. Further, the AI handling engine 120 provides an imported cloud resources-based AI architecture intelligent node suggestions. Further, the AI handling engine 120 detects missing or incorrectly placed nodes and provides fix recommendations. Further, the AI handling engine 120 recommends cost-efficient alternatives. Further, the AI handling engine 120 provides an AI chatbot for assistance. Further, the AI handling engine 120 provides interactive support for users 302 building architectures.

The architecture builder engine 404 at least one input or the query in the natural language. For example, Build a 3-tier web application on AWS with auto-scaling and a managed database.” The architecture builder engine 404 analyses the at least one input by using at the least one AI handling 126. The architecture builder engine 404 preprocesses, tokenizes, and vectorizes each word to pick up the cloud environment and the cloud components required for the HLD diagram. The architecture builder engine 404 identifies the relationships logically between each cloud component identified using the AI handling engine 126. The AI handling engine 126 is pre-trained with logical and visual relationship between each cloud components in each and every cloud environment. After identifying and establishing the logical relationships between the cloud components, the architecture builder engine 404 automatically generates the infrastructure as a diagram (IAD) for the cloud architecture based on the analysed at least one input. The architecture builder engine 404 validates the infrastructure as a diagram (IAD) by structuring the diagram logically and determining whether at least one layer of the infrastructure as a diagram (IAD) is in place.

The architecture builder engine 404 provides an intelligent cloud assistant helping to design, validate, and optimize the cloud infrastructure using natural language processing and automation. The architecture builder engine 404 accelerate cloud planning with minimal manual effort.

In an embodiment herein, the import handling engine 112 may analyse the imported cloud resources using the AI handling engine 126. The import handling engine 112 only needs to read the metadata about the resources for example, configurations, IDs, tags). The principle of least privilege means the import handling engine 112 is granted only the permissions the system 100 strictly needs to import the cloud resource from the existing cloud account, and nothing more. For Import, the scope is defined for read only actions, access may be limited to only relevant cloud accounts or regions, and temporal control is granted to the system 100 which is optionally time-bound with temporary credentials or session-based roles.The import handling engine 112 may automatically may map using the at least one artificial intelligence technique by the AI handling engine 126 the analyzed imported cloud resources into the visual high-level design (HLD) diagram by visually organizing the imported cloud resources.

In an embodiment herein, the import handling engine 112 automatically links the at least one active cloud resources and the at least one service available in the cloud environment to each other based on the logical relationship between the imported at least one active cloud resources and the at least one available service on the system 100, through the AI handling engine 126.

In an embodiment herein, the import handling engine 112 may identify automatically, at least one gap and at least one redundancy in the mapped diagram using the at least one artificial intelligence technique by the AI handling engine 126. The AI handling engine 126 may compare the connections in the created diagram with the pre-trained logical and visual connection of the cloud resources. The import handling engine 112 may highlight at least one area in the infrastructure as a diagram (IAD)that needs optimization.

In an embodiment herein, the system 100 may enable the user 302 to extend or modify the infrastructure as a diagram (IAD)using the architecture builder engine 404 and the AI handling engine 126, by receiving the query in natural language as disclosed in FIG. 4. The created infrastructure as a diagram (IAD)is then validated for misconfigurations, compliance issues, or inefficiencies (explained in FIG. 12). The system 100 generates the costing of the cloud infrastructure created according to the changes in the infrastructure as a diagram (IAD) (explained in FIG. 10). The HLD diagrams created using the import handling engine 112 can be reused or redeployed components as part of new workflows. The import handling engine 112 makes onboarding existing infrastructure effortless. The import handling engine 112 reduces rework, gain visibility into current cloud usage, and optimizes workflow.

In an embodiment herein, the AI handling engine 126 provides intelligent node suggestions. While creating or modifying the infrastructure as a diagram (IAD)for cloud architecture either manually or with AI assistance, the AI handling engine 126 runs a continuous intelligent analysis to validate and enhance the design. The AI handling engine 126 checks for missing components critical to application functionality, such as the warning if the stateful application lacks a database layer. The AI handling engine 126 also flags incorrect placements, like exposing cloud storage directly to the internet without proper network isolation or access control. The AI handling engine 126 may recommend better alternatives, such as replacing an over-provisioned virtual machine with the more cost-efficient managed service (e.g., switching from a self-hosted database to AWS RDS). The suggestions are not generic; the AI handling engine 126 provides tailored suggestions to improve cost-efficiency, performance, and security. The feature works in real time and encourages iterative improvements, helping to refine infrastructure early in the planning phase, before deployment and ultimately resulting in more robust, scalable, and secure cloud solutions.

In an embodiment herein, the AI handling engine 126 may receive the query in natural language from the user 302. The query is regarding at least one of: the guidance to create the infrastructure as a diagram (IAD), at least one suggestion for alternative component, the query to enhance the quality of the infrastructure as a diagram (IAD), the query to reduce the budget requirement, and at least one suggestion for the pricing, the validation, and the deployment workflow. The AI handling engine 126 may analyze the received query. The AI handling engine 126 provides real time interactive assistance for the received query and the contextual guidance in creating the at least one infrastructure as a diagram (IAD).

In an embodiment herein, the AI handling engine 126 may be pre-trained by receiving an input data associated with the at least one cloud component of the at least one cloud environment. The system 100 may identify a data format of the input data. The system 100 may pre-process the input data to clean data. The system 100 may generate vector embeddings of the input data. The system 100 may generate a machine learning model in the AI handling engine 126. The machine learning model is further trained with a labelled dataset for the at least one cloud component. The labelled dataset may include a cloud environment name, a cloud component name, a type of cloud component, and a visual and a logical relationship with the other at least one cloud component.

The AI handling engine 126 learns from patterns and improves with usage, making assistance more relevant over a period of time. The AI handling engine 126 continuously learns from user 302 interactions, deployment patterns, and past architectural decisions. Over time, the AI handling engine 126 builds a knowledge base of what configurations and choices lead to successful outcomes. Continuous learning allows the AI handling engine 126 to provide more context-aware suggestions and detect issues earlier. As usage increases, the AI handling engine 126 refines its models to better match specific user 302 needs and environments. The AI handling engine 126 adapts to different application types, scaling behaviors, and security requirements. The more the AI handling engine 126 is used, the more accurate and personalized its recommendations become. The AI handling engine 126 also identifies recurring inefficiencies and proposes optimized alternatives. Feedback loops from deployments, rollbacks, and manual overrides further enhance the learning. Ultimately, the AI handling engine 126 evolves into a smarter, more proactive assistant, improving the efficiency and reliability of future deployments.

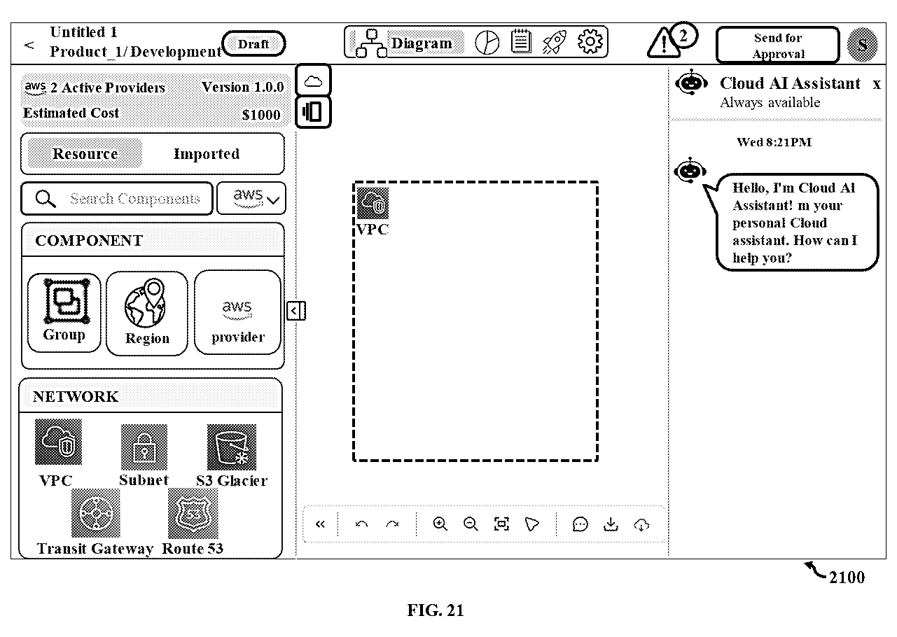

FIG. 21 shows an example screenshot 2100 illustrating the AI handling engine 126, according to embodiments as disclosed herein. The virtual interface 128 displays the canvas page with a panel for receiving the query through the AI chatbot.

FIG. 22 shows a block diagram 2200 for the compliance handling engine 132, according to embodiments as disclosed herein. The compliance handling engine 132 enables maintaining the cloud governance effortlessly by continuously monitoring the deployed infrastructure against the predefined policies. The compliance handling engine 132 keeps the cloud environments stay secure, compliant, and audit-ready without manual checks or surprises.

In an embodiment herein, the compliance handling engine 132 configures the compliance policies in the system 100 to define the rules and standards that cloud resources must follow. The policies configured are based on regulatory frameworks (like GDPR, HIPAA, or ISO), industry best practices, or internal security guidelines. The policies cover aspects such as data encryption, access controls, network configurations, and resource tagging.

In an embodiment herein, the organizations can define compliance policies using either standard frameworks (like CIS, HIPAA, or ISO 27001) or custom rules tailored to their specific needs. The policies may include requirements around data encryption, resource tagging, access controls, or network configurations. The standard policies ensure alignment with widely accepted security and regulatory practices. Custom policies allow the organizations to enforce internal governance rules, such as naming conventions or environment-specific controls. The policies are created using a rules engine or templates within the compliance system, allowing for flexibility and scalability. Once defined, these policies act as benchmarks against which all cloud resources are evaluated. The compliance handling engine 132 ensures that both external and internal compliance requirements are consistently met.

In an embodiment herein, the compliance handling engine 132 may receive a set of compliance policies in the form of policy templates or custom rules tailored to their organization's needs from the administrative user 308. The compliance handling engine 132 utilizes the received policies and sets the received policies as a benchmark to evaluate the compliance of deployed cloud infrastructure. The policies can be applied across different environments, accounts, or services to ensure consistent governance.

In an embodiment herein, the configuration process often includes setting conditions, defining severity levels, and determining response actions for violations. The configuration process may be compliant to standards for example Payment Card Industry Data Security Standard (PCI DSS) and Health Insurance Portability and Accountability Act (HIPAA).The structured setup ensures that all cloud operations align with the organization's compliance objectives from the start.

The configuration process is a critical step in establishing effective compliance monitoring. The compliance handling engine 132 may set specific conditions that cloud resources must meet, such as encryption enabled or proper network segmentation. The set conditions reflect security best practices, regulatory requirements, or internal governance policies. The administrative user 308 may then define severity levels for each policy violation, categorizing the level as low, medium, high, or critical based on potential impact. The classification of the violation helps prioritize responses and allocate resources effectively. The organizations may determine the appropriate response actions for each type of violation. The responses can include generating alerts, triggering automated remediation scripts, or even blocking non-compliant deployments. The ability to automate actions based on severity ensures faster and more consistent incident handling. All configurations are typically documented and version-controlled for auditability and traceability. The structured compliance policy setup ensures that compliance isn't reactive but proactively built into cloud operations. As a result, organizations can maintain continuous alignment with security and compliance goals from the day one.

In an embodiment herein, the compliance handling engine 132 may continuously scan the deployed cloud resources at regular intervals. The scanning is automated by a backend system. The compliance handling engine 132 continuously scans all deployed cloud resources at regular and predefined intervals to ensure they comply with configured policies. The compliance handling engine 132 may check for configuration changes, new deployments, or updates that could affect compliance status. By regularly inspecting the infrastructure, the compliance handling engine 132 maintains up-to-date visibility into the cloud environment. The compliance handling engine 132 identifies any drift or shift from approved configurations or security standards for policy enforcement. The scans are automated, reducing the need for manual checks and minimizing human error. The regular scanning ensures that compliance is maintained not just during deployment but throughout the resource lifecycle. The scanning process forms the foundation of continuous compliance monitoring. In an embodiment herein, the compliance handling engine 132 may prompt the user on the virtual interface 128 to provide the input to perform the scan of all deployed resources

In an embodiment herein, the compliance handling engine 132 may detect any deviations or violations from compliance policies in the real-time. The compliance handling engine 132 may continuously monitors cloud resources and instantly detects any deviations or violations from the configured compliance policies. The compliance handling engine 132 may compare the current state of each resource against the defined rules and standards. If a resource is misconfigured, altered, or falls out of compliance, the compliance handling engine 132 may flag the cloud resource immediately. Real-time detection ensures that issues are caught as soon as they occur, reducing the risk of security breaches or regulatory non-compliance. The proactive approach helps organizations address problems before they escalate. By identifying violations in real-time, the compliance handling engine 132 may support faster remediation and minimizes exposure. The compliance handling engine 132 may ensures that compliance is maintained dynamically, not just during periodic audits.

In an embodiment herein, the compliance handling engine 132 may detect any deviations or violations from compliance policies in real-time. When the compliance handling engine 132 detects the compliance violation or policy deviation, the compliance handling engine 132 immediately sends alerts and notifications to the relevant stakeholders. These alerts are delivered through preferred communication channels such as email, slack, or incident management tools. Each notification includes detailed information about the issue, including the affected resource, type of violation, and recommended actions. The immediate notification enables teams to quickly assess the situation and take corrective measures. Sending immediate alerts reduce response time, helping prevent potential security risks or compliance failures. The prompt communication ensures that no issue goes unnoticed or unresolved. As a result, the organizations can maintain a strong compliance posture with minimal delay.

In an embodiment herein, the compliance handling engine 132 has the following advantages: the continuous compliance monitoring reduce risk by catching non-compliance early. The compliance handling engine 132 detects violations as soon as they occur by continuously monitoring cloud resources, the system. The early detection helps prevent small misconfigurations from becoming serious security or compliance issues. The proactive approach of early compliance detection reduces exposure to threats and ensures faster resolution.

In an embodiment herein, the compliance handling engine 132 maintains comprehensive logs of all compliance checks, violations, and remediation actions. The log and records provide clear evidence for audits, demonstrating continuous adherence to policies. With readily available logs, the audit preparation becomes faster, easier, and less disruptive.

In an embodiment herein, the compliance handling engine 132 reduces the reliability on manual checks as the compliance handling engine 132 supports automated scanning. The automated compliance monitoring replaces repetitive manual reviews, reducing human error and saving time. The organization may focus on strategic projects instead of chasing misconfigurations or tracking policy changes with the help of automated compliance monitoring.

In an embodiment herein, the compliance handling engine 132 integrate seamlessly with the cloud operations and security workflows. The compliance handling engine 132 works alongside existing tools, deployment pipelines, and cloud platforms without major changes. The compliance handling engine 132 supports real-time alerts, role-based access, and API integration for smooth workflow alignment.

In an example scenario, the policy configured in the compliance handling engine 132 is policy name: Encrypt All S3 Buckets, policy type: security compliance. The ideal condition is all Amazon S3 buckets must have server-side encryption enabled (e.g., AES-256 or AWS-KMS). The severity if non-compliant to the policy is high. The response action set by the system 100 is trigger a real-time alert via email and Slack and log the event. Optionally, auto-remediate by enabling encryption or flagging for manual intervention. During a scheduled scan, the system 100 reviews all S3 buckets in the AWS environment. The compliance handling engine 132 finds that one bucket named marketing-assets-public does not have any server-side encryption enabled. The compliance handling engine 132 compares the configuration to the defined policy and identifies it as a high-severity violation. An alert is immediately sent to the cloud security team with the bucket name, region, and nature of the violation. The event is also logged in the compliance dashboard for future audits and tracking. Depending on the configuration, the compliance handling engine 132 may attempt to auto-enable encryption or quarantine the bucket until it's resolved.

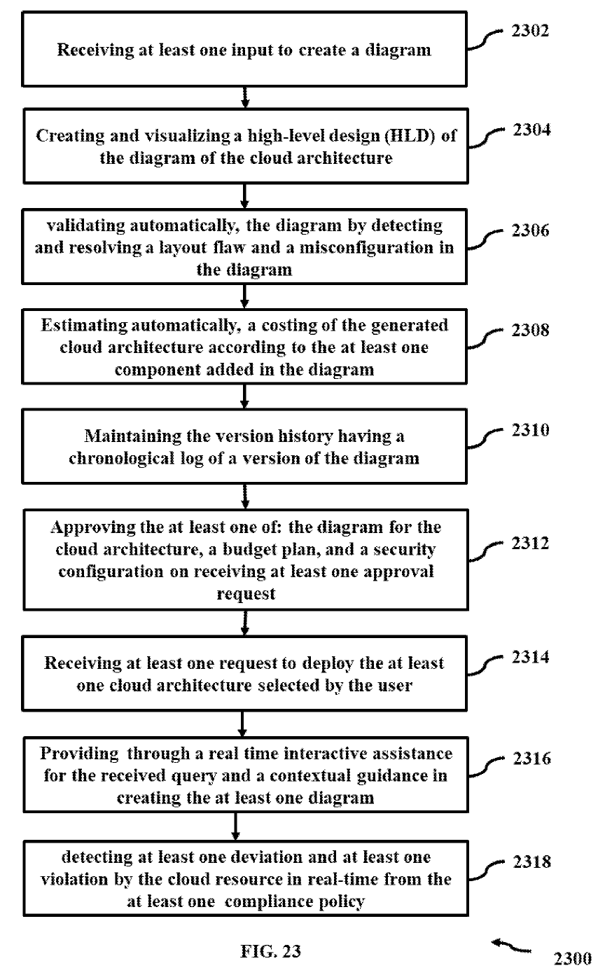

FIG. 23 shows a flowchart 2300 for a method for creating and managing the cloud infrastructure while cloud architectures remain compliant with predefined policies by continuously monitoring deployed resources, according to embodiments as disclosed herein. At step 2302, the system 100 may receive at least one input as the at least one component related to the cloud architecture on the visual interface 128 from the user 302 for creating the infrastructure as a diagram (IAD)for the cloud architecture. The input is received through the defined system template and the framework, importing at least one existing cloud resource, artificial intelligence powered query for automatic diagram generation, and dragging and dropping from the visual interface on the canvas page for creating the infrastructure as a diagram (IAD)of the cloud architecture.

At step 2304, the system 100 creates and visualizes the high-level design (HLD) of the diagram of the cloud architecture before deployment. At step 2306, the system 100 may validate automatically, the diagram generated by the at least one input, by detecting and resolving the layout flaw and the misconfiguration in the infrastructure as a diagram (IAD). At step 2308, the system 100 may estimate automatically, the costing of the generated cloud architecture according to the at least one component added in the diagram for the cloud architecture.

At step 2310, the system 100 may maintain the version history having the chronological log of the version of the infrastructure as a diagram (IAD) of the cloud architecture. The system 100 may save each version with the timestamp and the tag with the user identity, wherein the user identity is associated with the creator, the modifier, and an approver. At step 2312, the system 100 may approve the at least one of: the infrastructure as a diagram (IAD) for the cloud architecture, the budget plan, and the security configuration on receiving at least one approval request from the user 302.

At step 2314, the system 100 may receive at least one request to deploy the at least one cloud architecture selected by the user 302 from the list of approved cloud architecture. The system 100 may deploy at least one selected cloud architecture using an official cloud Software Development Kit (SDK) by directly interacting with the cloud network 802 eliminating the use of infrastructure as the code and eliminating the use of the Continuous Integration and Continuous Deployment (CI/CD) pipeline. At step 2316, the system 100 may provide through the at least one AI handling engine 126, real time interactive assistance for the received query and the contextual guidance in creating the at least one infrastructure as a diagram (IAD). At step 2318, the system 100 detects the at least one deviation and at least one violation by the cloud resource in real-time from the at least one compliance policy.

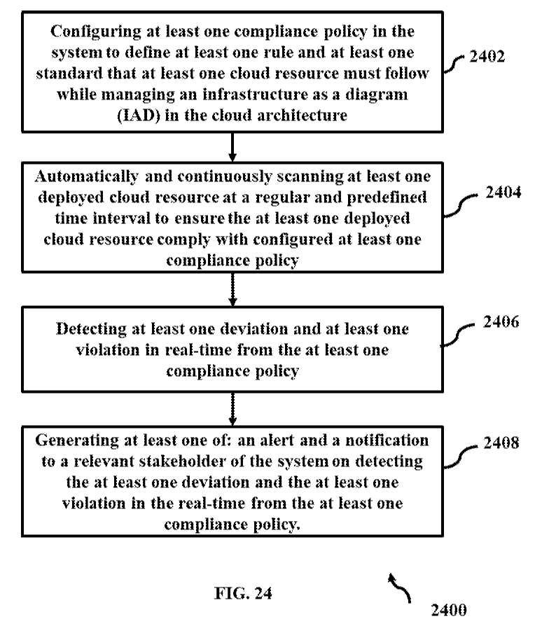

FIG. 24 shows a flowchart 2400 for a method for managing continuous compliance while managing the cloud infrastructure, according to embodiments as disclosed herein. At step 2402, the system 100 may configure at least one compliance policy in the system 100 to define at least one rule and at least one standard that at least one cloud resource must follow while managing an infrastructure as a diagram (IAD) in the cloud architecture. At step 2404, the system may automatically and continuously scan at least one deployed cloud resource at regular and predefined time interval to ensure the at least one deployed cloud resource comply with configured at least one compliance policy while managing the infrastructure as a diagram in the cloud architecture. At step 2406, the system 100 may detect at least one deviation and at least one violation in real-time from the at least one compliance policy while managing the infrastructure as a diagram in the cloud architecture. At step 2408, the system may generate the at least one of: an alert and a notification to a relevant stakeholder of the system on detecting the at least one deviation and the at least one violation in the real-time from the at least one compliance policy.

The embodiments disclosed herein can be implemented through at least one software program running on at least one hardware device and performing network management functions to control the network elements. The elements include blocks which can be at least one of the hardware device, or the combination of hardware device and software module.

The embodiments disclosed herein describe a system and method for creating and managing cloud infrastructures. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method for managing continuous compliance while managing a cloud infrastructure, the method comprising:
configuring, by a system, at least one compliance policy in the system to define at least one rule and at least one standard that at least one cloud resource must follow while managing an infrastructure as a diagram (IAD) in the cloud architecture;
automatically and continuously scanning, by the system, at least one deployed cloud resource at a regular and predefined time interval to ensure the at least one deployed cloud resource comply with configured at least one compliance policy while managing the infrastructure as a diagram in the cloud architecture;
detecting, by the system, at least one deviation and at least one violation in real-time from the at least one compliance policy while managing the infrastructure as a diagram in the cloud architecture; and
generating, by the system, at least one of: an alert and a notification to a relevant stakeholder of the system on detecting the at least one deviation and the at least one violation in the real-time from the at least one compliance policy.

2. The method of claim 1, wherein the cloud infrastructure is created by:
receiving, by the system, at least one input on an interface from a user for creating the infrastructure as a diagram (IAD) for the cloud architecture, wherein the at least one input comprises at least one component related to the cloud architecture;
automatically validating, by the system, the infrastructure as the infrastructure as a diagram (IAD) created by the at least one input, by detecting and resolving a layout flaw and a misconfiguration in the infrastructure as a diagram;
automatically estimating, by the system, a costing of the generated cloud architecture based on the at least one component added in the infrastructure as a diagram for the cloud architecture;
approving, by the system, the at least one of: a budget plan, and a security configuration for the infrastructure as a diagram for the cloud architecture, on receiving at least one approval request from the user;
receiving, by the system, at least one request to deploy the at least one cloud architecture selected by the user from a list of the approved cloud architecture;
creating and deploying, by the system, the at least one selected cloud architecture.

3. The method of claim 1, wherein configuring the at least one compliance policy comprises:
receiving, by the system, a set of compliance policy from an administrative user in a form of at least one policy template and at least one custom rule tailored to a particular organization's needs, wherein the compliance policy comprises at least one of: a regulatory framework, an industry best practice, and an internal security guideline, and wherein the policy covers aspects comprising at least one of: a data encryption, an access control, a network configuration, and a resource tagging; and
setting, by the system, the received at least one compliance policy as a benchmark to evaluate the compliance of deployed cloud infrastructure, wherein the at least one compliance policy is applied across different environments, accounts, or services to ensure consistent governance; and
wherein configuring at least one compliance policy comprises setting at least one condition, defining at least one severity level, and determining response actions for violations to align with an organization's compliance objectives.

4. The method of claim 1, wherein automatically and continuously scanning at least one deployed cloud resource comprises:
checking by the system, for at least one of: a configuration change, a new deployment, and an update that affects a compliance status by regularly inspecting the infrastructure; and
identifying by the system, at least one drift from an approved configuration and a security standard.

5. The method of claim 1, wherein detecting the at least one deviation and the at least one violation in real-time comprises:
comparing, by the system, a current state of each cloud resource against at least one configured rule and at least one standard; and
flagging, by the system, the cloud resource immediately when the cloud resource is misconfigured, altered, or falls out of compliance.

6. The method of claim 1, wherein the at least one alert is delivered through a communication channel comprising at least one of: an email, slack, or an incident management tool, and wherein each notification comprises detailed information about an issue, wherein the detailed information comprises at least one of: an affected resource, a type of violation, and a recommended action.

7. The method of claim 1, wherein the method comprises:
maintaining by the system, a log comprising all compliance checks, violations, and remediation actions about the infrastructure as a diagram for the cloud architecture.

8. The method as claimed in claim 1, wherein detecting, by the system, the at least one deviation and the at least one violation in the real-time from the at least one compliance policy comprises:
validating, by the system (100), the infrastructure as a diagram for the cloud architecture by performing automatic scans for at least one of: the cloud architecture, a cloud management role, a network security, an encryption, and a backup policy per organizational standard and a compliance framework;
detecting, by the system, the at least one deviation and the at least one violation in the real-time from the at least one compliance policy based on the validation.

9. The method as claimed in claim 8, wherein the method comprises blocking and flagging, by the system, at least one non-compliant request from an approval based on the detection.

10. The method as claimed in claim 1, wherein detecting, by the system, the at least one deviation and the at least one violation in the real-time from the at least one compliance policy comprises:
automatically and continuously scanning, by the system through an artificial intelligence (AI) handling engine, the at least one deployed cloud resource at the regular and predefined time interval to ensure the at least one deployed cloud resource comply with configured at least one compliance policy, wherein the AI handling engine utilizes a pre-trained AI handling module with a logical and a visual relationship between each cloud components in each and every cloud environment, and a set of compliance policy in the form of policy templates or custom rules tailored to the organization's needs from an administrative user;
comparing by the system through the AI handling engine (126), a current state of each cloud resource against the configured rules and standards; and
wherein pre-training of the AI handling engine comprises:
receives an input data associated with the at least one cloud component of the at least one cloud environment;
identifies a data format of the input data;
pre-processes the input data to clean data;
generates vector embeddings of the input data; and
generates a machine learning model, wherein the machine learning model is further trained with a labelled dataset for the at least one cloud component, wherein the labelled dataset comprises: a cloud environment name, a cloud component name, a type of cloud component, and a visual and a logical relationship with the other at least one cloud component, and a policy template and a custom rules tailored to the organization's needs, wherein the machine learning model learns from patterns and improves with usage from a user interaction, a deployment patterns, and a past architectural decision, making assistance more relevant over a period of time.

11. A system for creating and managing cloud infrastructure, comprising:
a memory; and
a processor, coupled with the memory, configured to:
configure at least one compliance policy in the system to define at least one rule and at least one standard that at least one cloud resource must follow while managing an infrastructure as a diagram (IAD) in the cloud architecture;
automatically and continuously scan at least one deployed cloud resource at a regular and predefined time interval to ensure the at least one deployed cloud resource comply with configured at least one compliance policy while managing the infrastructure as a diagram in the cloud architecture;
detect at least one deviation and at least one violation in real-time from the at least one compliance policy while managing the infrastructure as a diagram in the cloud architecture; and
generate at least one of: an alert and a notification to a relevant stakeholder of the system on detecting the at least one deviation and the at least one violation in the real-time from the at least one compliance policy.
